(19) United States
(12) Patent Application Publication
(10) Pub. No.: US 2013/0085785 A1
(43) Pub. Date: Apr. 4, 2013

(54) MEETING MONITORING AND COMPLIANCE ASSURANCE SYSTEM

(71) Applicant: Bloom Insurance Agency LLC, Bloomington, IN (US)

(72) Inventors: Sherman T. Rogers, Bloomington, IN (US); Brian D. Foreman, Bloomington, IN (US)

(73) Assignee: BLOOM INSURANCE AGENCY LLC, Bloomington, IN (US)

(21) Appl. No.: 13/631,479

(22) Filed: Sep. 28, 2012

Related U.S. Application Data
(60) Provisional application No. 61/541,810, filed on Sep. 30, 2011.
(60) Provisional application No. 61/705,682, filed on Sep. 26, 2012.

(51) Int. Cl. G06Q 99/00; G06Q 40/08

(52) U.S. Cl. 705/4; 705/317

(57) ABSTRACT

An illustrative system and method according to the present invention monitors in-the-field meetings of representatives with customers, for example, marketing and sales activity. The system includes a central data system and a portable wireless device (e.g., tablet device, smartphone, etc) deployed with each representative. The portable wireless devices are equipped with a special software application (the “mobile application”) and also a communications device(s) for communicating with the central data system. The portable wireless device provides availability of the representative to the central data system and a guided meeting process, including collection of information, presentation of meeting content, and optional audio recording of the meeting. More particularly, the system can be used for monitoring in-the-field sales of regulated products, such as financial services, including insurance product sales. The monitoring can include guiding, documenting, and providing centralized assurance of regulatory and non-regulatory compliance during representatives' meetings with customers.

### CROSS-REFERENCE TO RELATED APPLICATIONS

This application is a U.S. Nonprovisional patent application of U.S. Provisional Patent Application Ser. No. 61/541,810, filed Sep. 30, 2011, and U.S. Provisional Patent Application Ser. No. 61/705,682, filed Sep. 26, 2012, both titled Regulatory Compliance Assurance System, each of which are hereby incorporated fully by reference.

### COPYRIGHT NOTICE

A portion of the disclosure of this patent document contains material which is subject to copyright protection. The copyright owner has no objection to the facsimile reproduction by any-one of the patent document or the patent disclosure, as it appears in the patent and trademark office patent file or records, but otherwise reserves all copyright rights whatsoever.

### BACKGROUND

The present invention relates to systems that provide centralized monitoring of in-the-field meetings, and particularly, to systems that provide monitoring of sales or marketing meetings, including guiding and ensuring regulatory and non-regulatory compliance for in-the-field insurance and financial product sales.

In-the-field meetings of representatives with customers are inherently difficult and costly to monitor for compliance with company best practices, policies and procedures, and legal requirements. The difficulty of observing and documenting compliance during in-the-field sales and marketing meetings relating to insurance and financial products, often taken place at a customer's residence, is especially concerning given the high level of regulation by various state and federal agencies.

Compliance assurance is especially difficult for companies with complex disclosures and product offers that vary depending on the geographic location or other demographic or need of a customer with whom a representative is meeting. This is especially true for insurance agencies having agents (or more broadly, “representatives”) that handle disclosures and enrollments for multiple product offerings from a number of different insurance carriers.

Senior market sales in the insurance industry, particularly the Medicare Advantage insurance sales market, is an especially highly regulated industry. For example, regulatory changes promulgated annually by the US Department of Health & Human Services, Centers for Medicare & Medicaid Services (“CMS”), have been numerous and complex in recent years, making it very difficult for industry participants to understand and fully implement systems and procedures that ensure compliance. Additionally, harsh, punitive consequences have been placed on industry participants accused of compliance issues such as improper product information disclosures to customers.

Such consequences include sanctioning the company by forbidding sales for a period of time, and requiring proof that compliance will be achieved before sales activity is again authorized. Minimizing complaints by ensuring compliance is thus critical for market participants. As a result of these concerns and because of the cost barrier to adequately monitoring and documenting in-the-field meetings to ensure compliance requirements are satisfied, many participants in the insurance sales and other industries have implemented a defensive selling strategy that likely has a detrimental effect on success and profitability in the market place.

To add to the challenge, in some cases, final guidance on regulatory changes relating to the sale of Medicare Advantage products are not issued by the CMS until several weeks before the effective date of the requirements. Therefore, the time available to prepare and distribute compliant meeting content, for example insurance product sales documents, to develop compliant meeting procedures, and to train representatives is insufficient for a field sales staff that is national in scope. Medicare Advantage, and its associated complex and demanding sales related regulations, is just one of the many insurance and financial products and other industries that require compliance assurance.

Additionally, even with sufficient time to prepare, it can be challenging to provide correct and timely in-the-field disclosures of information such as product pricing, benefits, and other critical information for products. Further increasing the challenge, critical information with compliance implications and that is presented during in-the-field meetings typically varies depending on the demographics of the customer, including the residential county or zip code of the customer. Additionally, keeping printed materials that are carried in-the-field by representatives up to date and that important messages are reviewed is very hard to ensure. In some cases, when the open rate of important emails in a business setting was reviewed, only 18-30% of recipients actually opened the emails.

To solve these compliance assurance challenges, insurance companies in particular are taking various aggressive measures, yet still struggle to monitor, achieve, and document full compliance. Such measures include increasing support staff to enhance procedures and compliance, increasing training for representatives, conducting more monitoring by supervisors during in-the-field meetings, and decreasing the size of the sales force to more manageable numbers.

Insurance sales and meetings that are conducted over-the-phone from a central office can be more easily periodically supervised and always recorded. Additionally, networked computer systems can be accessed during such sales calls to help guide the conversation and to provide access to a database or other software tool that provide correct product quoting and other information specific to the needs of a particular customer, thus providing a higher level of compliance and documentation than in-the-field meetings that often utilize only printed literature.

While supervision and audits may improve compliance, providing enough personnel in-the-field for daily supervision of representatives and reoccurring compliance audits is cost prohibitive and impractical.

Existing systems used in call centers for over-the-phone insurance sales provides guidance to representatives, for example, in the form of a series of needs analysis and demographics questions. Additionally, a software system, often referred to as a quote engine, uses basic demographic and other information obtained about customers to develop quotations for applicable products (including from multiple carriers, if desired) that are available for their specific needs. Additionally, phone systems used in such centralized call centers are sometimes used to record sales calls to help later assess regulatory compliance.

While various quote engines are available remotely via the internet, for example, for insurance and financial products, travel services, etc., facilitating a selection among available products and providing a quote is only a portion of the process of completing an insurance or financial product transaction during a meeting between a representative and customer. Additionally, such quote engines or online electronic applications that limit the risk of losing an application and associated personal and health information generally require an internet connection, which may not be available in the location of an in-the-field meeting, for example, in a customer's home. Furthermore, although electronic documents that are verified to be the latest version can be provided on a server based portal for representatives to download, presently known systems do not verify that representatives have downloaded and used the latest documents in a particular meeting with a customer. Therefore, it is desirable to provide a means for guiding, monitoring, and documenting meetings that ensures regulatory and other desired compliance in a single, integrated system that is functional, affordable, and effective for in-the-field meetings.

With an in-the-field sales force, for example as employed with Field Marketing Organizations (FMOs), it is also advantageous to enable electronic communication with a central data system, including providing information such as the present location of representatives, what a representative's availability is, what representatives are doing with leads, what representatives are and are not communicating to customers during meetings, and whether critical messages, meeting content updates, and sales checklist updates have been received and are being used by each representative. Additionally, it is desirable to provide central access to information collected about in-the-field meetings so that trends and outliers can be identified early and redressed. Also, specific to the insurance and financial industries, it desirable to enable quicker enrollment and validation of enrollment data, in part so that representatives can receive commissions from the sale more quickly than is provided by presently known systems.

### SUMMARY

The present invention may comprise one or more of the features recited in the attached claims, and/or one or more of the following features and combinations thereof.

An illustrative system and method according to the present invention monitors in-the-field meetings of representatives with customers, for example, in-person marketing and sales activity in the insurance industry. The system includes a central data system and a portable wireless device (e.g., tablet device, smartphone, etc) deployed with each representatives. The portable wireless devices are equipped with a special software application (the “mobile application”) and also a communications device(s) for communicating with the central data system. The portable wireless device provides a guided meeting process, including collection of information, presentation of meeting content, and optional audio recording of the meeting. More particularly, the system can be used for monitoring in-the-field sales of regulated products, such as financial services, including insurance product sales. The monitoring can include guiding, documenting, and providing centralized assurance of regulatory and non-regulatory compliance during representatives' meetings with customers.

An illustrative system according to the present invention can also provide automated meeting content distribution and updating (including documents), message distribution and tracking of required message acknowledgments, audio recording of meetings, and capturing the geographic location of meetings. When used for in-the-field sales of Medicare Advantage, the illustrative system assists companies in discovering and solving representative communication problems with customers before compliance becomes an issue elevated to CMS, and implements policies, procedures, and best practices in insurance sales and marketing workflow.

The present system provides many advantages, for example, it can facilitate accurate provision of detailed and updated product information, accurate quotation of premiums, documentation of what was actually said and what meeting content was reviewed in meetings, and avoids errors and delays associated with handwritten applications. Such previously handwritten applications would be keyed into a software system by a third individual, often introducing further errors in reading or keying and delays in processing for enrollment. The present system can provide in-the-field electronic enrollment using the mobile software application, including data checking to ensure accurate and complete information is collected from the customer during the in-the-field meeting, and the meeting data set generated by the mobile software application is then immediately available for processing and enrollment. The collection of correct enrollment data is critical and often the source of a lot of later expended time to correct data if the first collection of enrollment data is not correct, thus this feature is very advantageous. For example, a subscriber's Medicare number entered incorrectly prevents enrollment, or a medical service provider not specified delays enrollment of the customer in the plan until contact is made and the correct data obtained and entered.

Updating of plan benefits, provider listings, and other meeting content is provided with electronic distribution of meeting content, including documents which can be in an easily printable format. Meeting content can be pushed out to the representatives, for example, in the form of a download instruction or other message that must be completed or otherwise acknowledged before the sales guidance process can be engaged for the products having newly updated meeting content available for download, or in the form of an automatic or selected download once the representative has logged in. This feature ensures that the representative has obtained the current copy of all applicable meeting content used during a meeting, and ensures that 100% of messages requiring acknowledgment have been acknowledged before a meeting is conducted.

The present system concept is applicable to other health insurance products other than Medicare Advantage, including dental and Medicare Supplement, and to other forms of insurance products outside of the health insurance industry, for example, life insurance. The system concept may also be applied outside the insurance industry to other commercial or non-commercial activities for which there is a need to centrally monitor, for example, including other financial services industries, including banking and various types of financial brokerage activity, especially those that require compliance with a strict set of regulations or other requirements.

Recording of meetings is also important in the highly regulated insurance and financial services industries because experience has shown that customers sometimes claim that a particular disclosure was not made to them by the representative, or that a disclosure that was made to them by the representative was different than what the representative claims, while an audio recording provides proof of what was communicated. Therefore, in industries with strict regulatory compliance or liability issues, easily capturing and centrally archiving and accessing audio recordings of each in-the-field meeting in an integrated system that also includes retrieval of enrollment and sales documentation is advantageous.

The illustrative system can also provide distribution of important messages to representatives and meeting content for use by the representatives in meetings, including for example, documents shown to and/or provided to customers. Additionally, each representative's downloading of meeting content and acknowledgment of messages can be tracked and verified by the system. Meeting content and messages can include an associated date to publish, date to expire, and receipt acknowledgment status. Downloading of new or updated meeting content and messages by the portable wireless device can be provided automatically as soon as a representative is logged in and has connectivity to a central data system.

The illustrative system also facilitates identifying an available representative for lead prospecting, setting appointments, producing a scope of appointments, and generally condensing the sales cycle into a shorter process and timeframe. Also, the system provides a flow of data that connects from a lead, to an appointment, to a meeting, and to an outcome, for example an application or other sale or contract. Additionally, the system develops an audit trail of the process, including lead prospecting, appointments, information received, materials and other disclosures presented, enrollment information collected, etc.

The illustrative system can provide a guided meeting process, implemented by the mobile application, that prevents continuation of the process in the event an audit/compliance issue arises or is at risk if the process continues to the desired next step, thereby providing compliance assurance.

The illustrative system also provides an extensive analysis and reporting system that monitors and identifies meetings, representatives, performance trends, exceptions, and outliers, both favorable and unfavorable, historic and in real-time, and provides means to facilitate regulatory and nonregulatory compliance assurance, including for example, compliance with policies, procedures, and identified best practices.

One illustrative system for monitoring meetings of a representative with customers in the field, includes a central data system having an management application; a portable wireless device having a mobile application and geographic locating capability, the representative having the portable wireless device at meetings in the field with customers; and a service layer application enabling communication between the mobile application and management application; the mobile application enabling monitoring of meetings with customers, the monitoring including: an availability status indicating at least whether or not the representative is presently available, the availability status transmitted immediately to the central data system; a guided meeting process used by the representative, including: presentation of meeting content; collection of meeting information, including at least geographic location determined by the portable wireless device; and collection of customer information; and receiving messages from the management application; and the monitoring further includes: tracking acknowledgment of the messages, the acknowledgment provided by the representative using the portable wireless device; and the mobile application inhibiting the guided meeting process if message designated as requiring acknowledgment is not yet acknowledged; and the meeting information and at least a portion of the customer information transmitted from the portable wireless device to the central data system and accessible by the management application.

The management application may also enable compliance analysis and reporting based on the meeting information and customer information received by the central data system from the mobile application. The compliance analysis and reporting may also include determining representatives having an averaged member of at least one of meeting information data and customer information data that is a statistical outlier. The compliance analysis and reporting may include comparison of representatives' rates of one of the meeting information data.

The customer information may include insurance product enrollment information. The compliance analysis and reporting may include comparison of representatives' rates of enrollment. The meeting content may include insurance product offering and the guided meeting process further includes insurance product enrollment.

The guided meeting process may include validation that customer information and meeting information are compliant. The compliance analysis and reporting may include comparison of representatives' rates of compliance. The meeting information may include a final disposition of the meeting with the customer, the final disposition selected from a plurality of possible meeting dispositions. The compliance analysis and reporting may include comparison of representatives' rates for at least one of the plurality of possible meeting dispositions.

The compliance analysis and reporting may include calculation and display of, for a selected period of time and a selected group of representatives, the number of meetings and meeting dispositions for at least one of the plurality of possible dispositions. The meeting information may include the length of the meeting with the customer. The compliance analysis and reporting may include comparison of representatives' average lengths of the meetings with customers. The portable wireless device may include GPS capability and the geographic location is determined by the GPS capability. The availability status can be determined by the representative selecting one of a plurality of different availability statuses selectable by a touchscreen softswitch displayed by mobile application. The mobile application may enable transmission of the geographic location to the management application.

The mobile application may enable storing on the portable wireless device meeting content for use in the meetings, the meeting content including documents; and the monitoring may further include: automatic updating of meeting content on the portable wireless device with documents published by the management application; and the mobile application inhibiting the guided meeting process in the event updated meeting content is available from the management application and is not yet downloaded to the portable wire device.

The compliance analysis and reporting may include calculation and display of, for a selected period of time and a selected group of representatives, a rate of downloading of meeting content to portable wireless devices. The management application may enable setting for each meeting content, a publish date on which the meeting content becomes available to the mobile application, and an expiration date on which the meeting content is no longer accessible using the mobile application. The mobile application may enable receiving messages from the management application; and the monitoring may further include tracking acknowledgment of the messages, the acknowledgment provided by the representative using the portable wireless device; and the mobile application inhibiting the guided meeting process if message designated as requiring acknowledgment is not yet acknowledged. The compliance analysis and reporting may include calculation and display of, for a selected period of time and a selected group of representatives, a rate of acknowledgment of messages.

The management application may further enable setting for a message, a publish date on which the message becomes available using the mobile application, and an expiration date on which the message is no longer accessible using the mobile application. The monitoring may further include: setting in the management application authorizations for the representative for particular meeting content; and the guided meeting process inhibiting particular meeting content for which the representative lacks authorization. The monitoring may further include: setting in the management application the availability and features of meeting content based on a geographic location of the customer; and the guided meeting process accessing meeting content based at least in part on the geographic location of the customer.

The meeting information may further include whether the customer consented to recording of the meeting; and the monitoring may further include audio recording of the meeting when consent is obtained from the customer. The compliance analysis and reporting may include comparison of representatives' rates of customers consenting to the recording of the meeting. The compliance analysis and reporting may include comparison of representatives' rates of transmission of audio recording of meetings to the central data system.

The mobile application may provide login credentials to the service layer application; the service layer application may transmit a time-limited token to the mobile application upon validation of login credentials; and the guided meeting process may be enabled by the mobile application upon availability of a time-limited token that is unexpired and wireless conductivity between the portable wireless device and the central data system; and a portion of the guided meeting process may be disabled by the mobile application upon availability of a time-limited token that is unexpired and no availability of wireless conductivity between the portable wireless device and the central data system; and the guided meeting process may be disabled by the mobile application upon expiration of the time-limited token and no availability of wireless conductivity between the portable wireless device and the central data system to obtain an unexpired time-limited token.

The mobile application may enable a delay of transmission of meeting information and customer information until connectivity is available between the portable wireless device and the central data system; and the mobile application may inhibit the guided sales process if the delay of transmission exceeds at least one of a preset length of time and a preset number of meetings. Wherein the mobile application enables access to meeting content from a third-party server during the guided meeting process.

The mobile application may be integrated with a third-party customer relationship management system to exchange customer information and meeting information. The compliance analysis and reporting may include the number of meetings and meeting dispositions. The management application may enable display of a map indicating locations of representatives and their availability. The management application may further enable display of an activity dashboard indicating statistics for a select period of time and selected group of representatives based on meetings, final disposition of meetings, audio recordings, geographic locations captured and other metrics. The management application may further enable display of an exception dashboard indicating statistics for a select period of time and selected group of representatives based on meeting duration, final disposition of meetings, audio recordings, geographic locations captured and other metrics.

Another illustrative embodiment of a system for monitoring meetings of a representative with customers in the field, includes a central data system having a management application; a portable wireless device having a mobile application and geographic locating capability, the representative having the portable wireless device at meetings in the field with customers; and a service layer application enabling communication between the mobile application and management application; the mobile application enabling monitoring of meetings with customers, the monitoring including: a guided meeting process used by the representative, including: presentation of insurance information; collection of meeting information, including at least geographic location determined by the portable wireless device; and collection of customer information, including at least insurance product enrollment information; and the meeting information and at least a portion of the customer information transmitted from the portable wireless device to the central data system and accessible by the management application.

An illustrative method for monitoring meetings of a representative with customers in the field, includes the steps of: providing meeting content, including documents, using a central data system; providing a portable wireless device, a login credential, and an authorization for particular meeting content to each of a plurality of representatives, the portable wireless device having geographic locating capability; one of the plurality of representatives using a mobile application on the portable wireless device to conduct meetings, the mobile application enabling the further steps of: validation of login credentials; providing an availability status for the one of the plurality of representatives, the availability status indicating at least whether or not the representative is presently available and transmitted immediately to the central data system; accessing the meeting content; guiding the meeting; audio recording of the meeting; determining meeting information, the meeting information including geographic location determined by the portable wireless device; determining customer information; and

transmission of audio recording, meeting information, and customer information to the central data system.

The method may further include the steps of: providing messages using a central data system; and the one of the plurality of representatives acknowledging receipt of the messages. The meeting information may include a final disposition of the meeting. The meeting information may include a duration of the meeting. The method may further include the steps of: obtaining consent to record audio of the meeting; and transmitting whether consent was obtained to the central data system. The availability status is determined by the representative selecting one of a plurality of different availability statuses selectable by a touchscreen softswitch displayed by mobile application. The method may further include the step of the one of the plurality of representatives providing an availability status, and the availability status transmitted to the central data system.

The method may further include the step of inhibiting particular meeting content for which the one of the plurality of representatives lacks authorization. The method may further include the step of inhibiting the mobile application from guiding the meeting process if at least one of audio recordings or meeting information has not been transmitted to the central data system. The method may further include the step of inhibiting the mobile application from guiding the meeting process if the one of the plurality of representatives has not yet acknowledged a message designated as requiring acknowledgment. The method may further include the step compliance analysis and reporting for the plurality of representatives. The step of compliance analysis and reporting may include determining representatives of the plurality of representatives having an averaged member of at least one of meeting information data and customer information data that is a statistical outlier.

The customer information may include insurance product enrollment information. The meeting content may include insurance product offering and the step of guiding the meeting includes insurance product enrollment. The method may further include the step of validating that customer information and meeting information are compliant. The method may further include the step of the central data server proving automatic updates of the meeting content stored on the portable wireless device. The method may further include the step of determining the meeting content for a meeting at least in part based on the geographic location of a customer attending that meeting.

Additional features of the present invention will become apparent to those skilled in the art upon consideration of the following detailed description of the illustrative embodiment.

### BRIEF DESCRIPTION OF THE DRAWINGS

The detailed description particularly refers to the accompanying figures in which:

FIG. 1 is a schematic block diagram of an illustrative embodiment of the system according to the present invention;

FIG. 2 is a process diagram of an illustrative embodiment of an integrated monitoring and compliance assurance process according to the present invention and implemented by the system of FIG. 1;

FIG. 3 is a process diagram illustrating a guided meeting process according to the present invention and implemented by the system of FIG. 1;

FIG. 4 is an illustrative GUI layout diagram of a desktop for a portable wireless device implementing the mobile application of FIGS. 1 and 3;

FIG. 5 is an illustrative GUI layout diagram for a login screen associated with a login step of the mobile application of FIGS. 1 and 3;

FIG. 6 is an illustrative GUI layout diagram for a message screen associated with a message acknowledgment step of the mobile application of FIGS. 1 and 3;

FIG. 7 is an illustrative GUI layout diagram for a message screen with an availability overlay associated with a representative availability step of the mobile application of FIGS. 1 and 3;

FIG. 8 is an illustrative GUI layout diagram for a start meeting screen associated with a initiation of meeting step of the mobile application of FIGS. 1 and 3;

FIG. 9 is an illustrative GUI layout diagram for a disclaimer screen associated with an audio recording consent step of the mobile application of FIGS. 1 and 3;

FIG. 10 is an illustrative GUI layout diagram for a client information screen associated with a collect basic customer information step of the mobile application of FIGS. 1 and 3;

FIG. 11 is an illustrative GUI layout diagram for a plan listing screen associated with a meeting content presentation step of the mobile application of FIGS. 1 and 3;

FIG. 12 is an illustrative GUI layout diagram for a pre-enrollment checklist screen associated with a meeting checklist step of the mobile application of FIGS. 1 and 3;

FIG. 13 is an illustrative GUI layout diagram for an enrollment information screen associated with a collect further customer information step of the mobile application of FIGS. 1 and 3;

FIG. 14 is an illustrative GUI layout diagram for a disposition screen associated with a disposition of meeting step of the mobile application of FIGS. 1 and 3;

FIG. 15 is an illustrative GUI layout diagram for an end meeting screen associated with an end meeting step of the mobile application of FIGS. 1 and 3;

FIG. 16 is an illustrative GUI layout diagram for an recording upload screen associated with a data transmission step of the mobile application of FIGS. 1 and 3;

FIG. 17 is an illustrative GUI layout diagram for an meeting start blocked screen associated with a guided meeting process inhibited feature of the mobile application of FIGS. 1 and 3;

FIGS. 18A and 18B are the upper partial view and lower partial view, respectively, of an illustrative GUI layout diagram for an add a user screen associated with a user management feature of the management application of the system of FIGS. 1 and 2;

FIG. 19 is a illustrative GUI layout diagram of a user listing screen associated with a user management feature of the management application of the system of FIGS. 1 and 2;

FIG. 20 is a illustrative GUI layout diagram of a group listing screen associated with a group management feature of the management application of the system of FIGS. 1 and 2;

FIG. 21 is a illustrative GUI layout diagram of a documents listing screen associated with a meeting content feature of the management application of the system of FIGS. 1 and 2;

FIG. 22 is a illustrative GUI layout diagram of an add document screen associated with a meeting content feature of the management application of the system of FIGS. 1 and 2;

FIG. 23 is a illustrative GUI layout diagram of a message listing screen associated with a message distribution feature of the management application of the system of FIGS. 1 and 2;

FIG. 24 is a illustrative GUI layout diagram of an add message screen associated with a message distribution feature of the management application of the system of FIGS. 1 and 2;

FIG. 25 is a illustrative GUI layout diagram of an message acknowledgment screen associated with a message distribution feature of the management application of the system of FIGS. 1 and 2;

FIG. 26 is a schematic diagram showing illustrative monitoring features of the management application of the system of FIGS. 1 and 2;

FIG. 27 is an illustrative GUI layout diagram for a meeting search and listing feature associated with the management application of the system of FIGS. 1 and 2;

FIGS. 28A and 28B are the left partial view and right partial view, respectively, of an illustrative report layout for a detailed meeting feature associated with the management application of the system of FIGS. 1 and 2;

FIG. 29 is an illustrative report layout for a meeting disposition feature associated with the management application of the system of FIGS. 1 and 2;

FIG. 30 is an illustrative report layout for a meeting disposition by representative feature associated with the management application of the system of FIGS. 1 and 2;

FIG. 31 is an illustrative GUI layout for an activity dashboard feature associated with the management application of the system of FIGS. 1 and 2;

FIG. 32 is an illustrative GUI layout for an exceptions reporting dashboard feature associated with the management application of the system of FIGS. 1 and 2;

FIG. 33 is an illustrative report layout for a meeting duration exception feature associated with the management application of the system of FIGS. 1 and 2;

FIG. 34 is an illustrative report layout for a meeting duration exception breakpoint feature associated with the management application of the system of FIGS. 1 and 2;

FIG. 35 is an illustrative report layout for an applications submitted exception feature associated with the management application of the system of FIGS. 1 and 2;

FIG. 36 is an illustrative report layout for a recording availability general exception feature associated with the management application of the system of FIGS. 1 and 2;

FIG. 37 is an illustrative report layout for a recording availability detailed exception feature associated with the management application of the system of FIGS. 1 and 2;

FIG. 38 is an illustrative report layout for a location captured exception feature associated with the management application of the system of FIGS. 1 and 2;

FIG. 39 is an illustrative report layout for a location captured detailed exception feature associated with the management application of the system of FIGS. 1 and 2;

FIG. 40 is an illustrative GUI layout for a meeting and representative status and location feature associated with the management application of the system of FIGS. 1 and 2;

FIG. 41 is a first feature flow diagram showing illustrative compliance reporting, analysis, and action features of the management application of the system of FIGS. 1 and 2; and

FIG. 42 is a second feature flow diagram showing illustrative compliance analysis, reporting, and action features of the management application of the system of FIGS. 1 and 2.

### DESCRIPTION OF THE ILLUSTRATIVE EMBODIMENTS

For the purposes of promoting and understanding the principals of the invention, reference will now be made to one or more illustrative embodiments depicted in the drawings and specific language will be used to describe the same.

System Overview

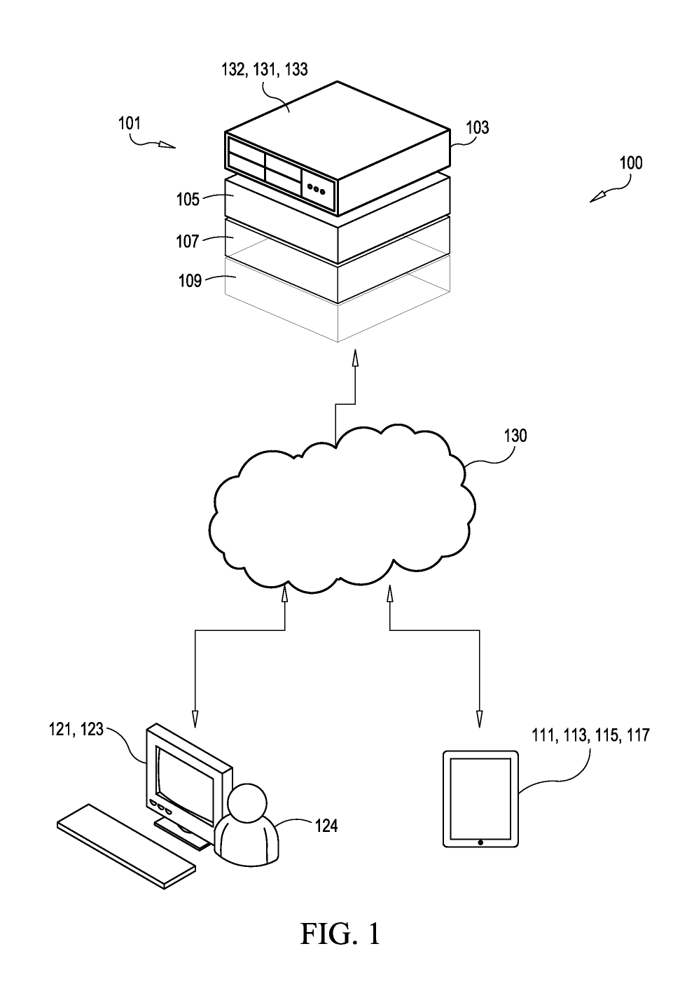

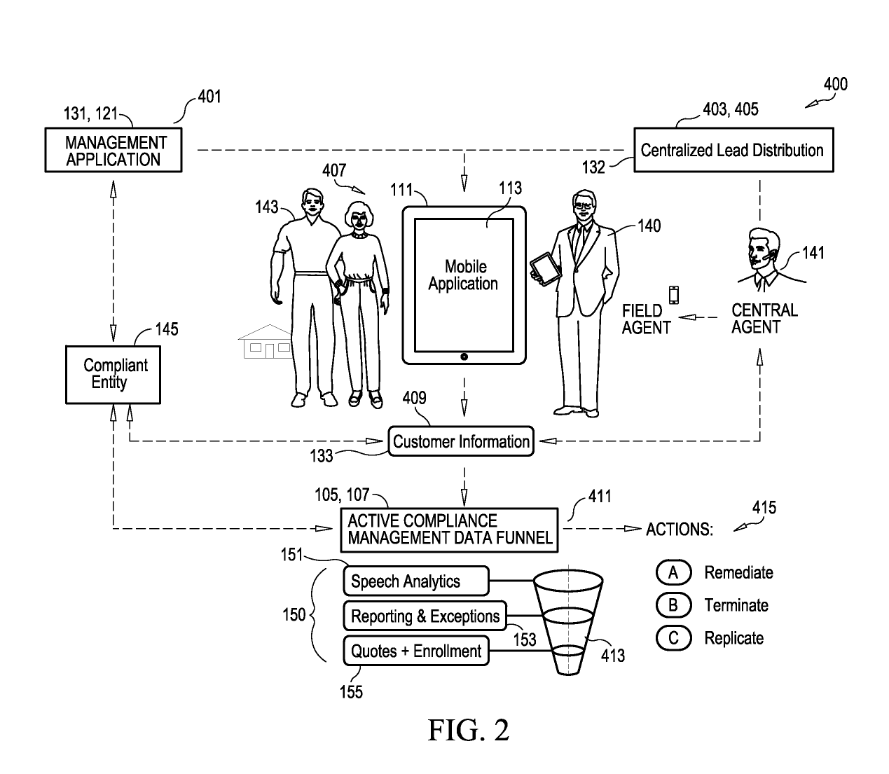

Referring to FIG. 1, an illustrative embodiment of system 100 provides monitoring of in-the-field meetings of representatives with customers, for example, in-person marketing and sales activity in the insurance industry. The system 100 includes a central data system 101 and a plurality of portable wireless devices 111 (e.g., a tablet computer, smartphone, or other hand-portable wireless computing devices). The central data system 100 includes a server computer 103, a database 105, and a meeting content and recording data storage medium 107. The portable wireless devices 111 are each deployed for use by a representative 140 (FIG. 2), typically working in-the-field, i.e., distant from central data system 101, and each portable wireless device 111 is equipped with a mobile application 113 and a communications device(s) 115 for communicating with the central data system 101, for example, over the internet or another wired, wireless, or multipath wide area network (WAN) 130.

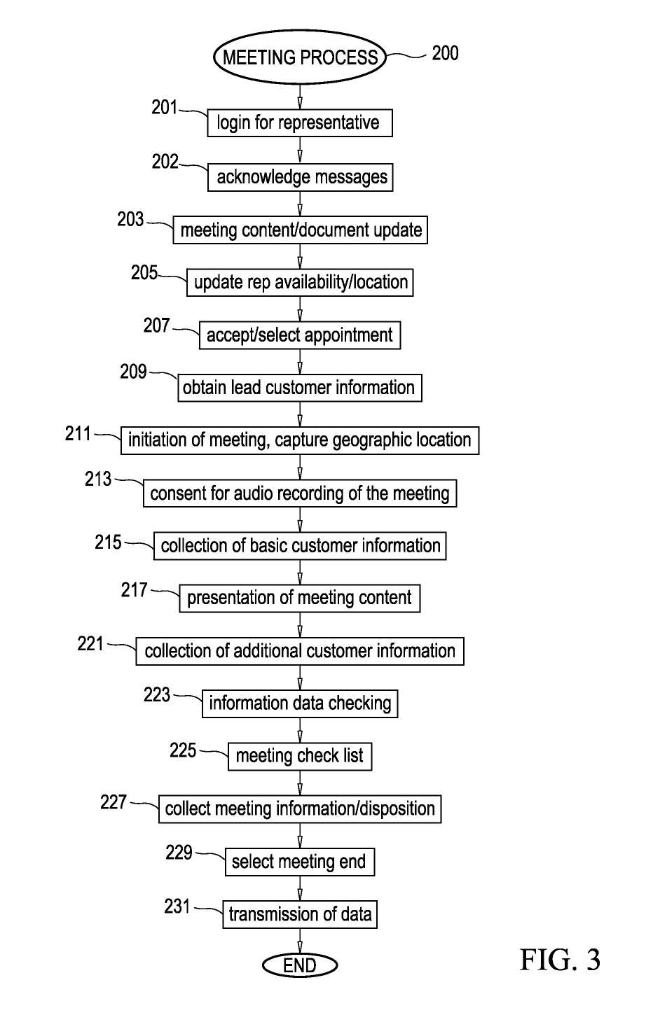

More particularly, the system 100 implements an integrated monitoring process 400, shown in FIG. 2, for example, that can be used for centralized compliance monitoring of regulatory and non-regulatory aspects of in-the-field meetings, for example, for highly regulated industries, such as the financial services industry, including insurance sales, for example, including sales of Medicaid and Medicare insurance products. Monitoring relating to the activities of representatives 140 and 141 with customers (including clients and prospects) 143 is provided by the various features of the system 100, including a guided meeting process 200 (FIG. 3) and the monitoring process 400 (FIG. 2), which includes compliance tools 150 (FIG. 2).

The system 100 also includes a management application 131 for implementing the features of the monitoring process 400. The management application 131 is associated with the central data system 101 and also can include other software and/or hardware components known in the art that are used to efficiently implement the features of the monitoring process 400 and system 100. The management application 131 provides real-time management (RTM) of representatives, representative roles, messages, meeting content (including for example, product information), appointments and workflow, customer information, and analysis and reporting.

The management application 131 can be accessed by an administrator 124 at the central server 101, or by logging into the management application using a management software interface 121, for example a web browser, from another computing device 123, for example, over the WAN 130. A service layer application 109 is also associated with the central data system 101 and enables communication, security, and other interaction between the mobile application 113, the management application 131, the management software interface 121, the database 105, and the storage medium 107.

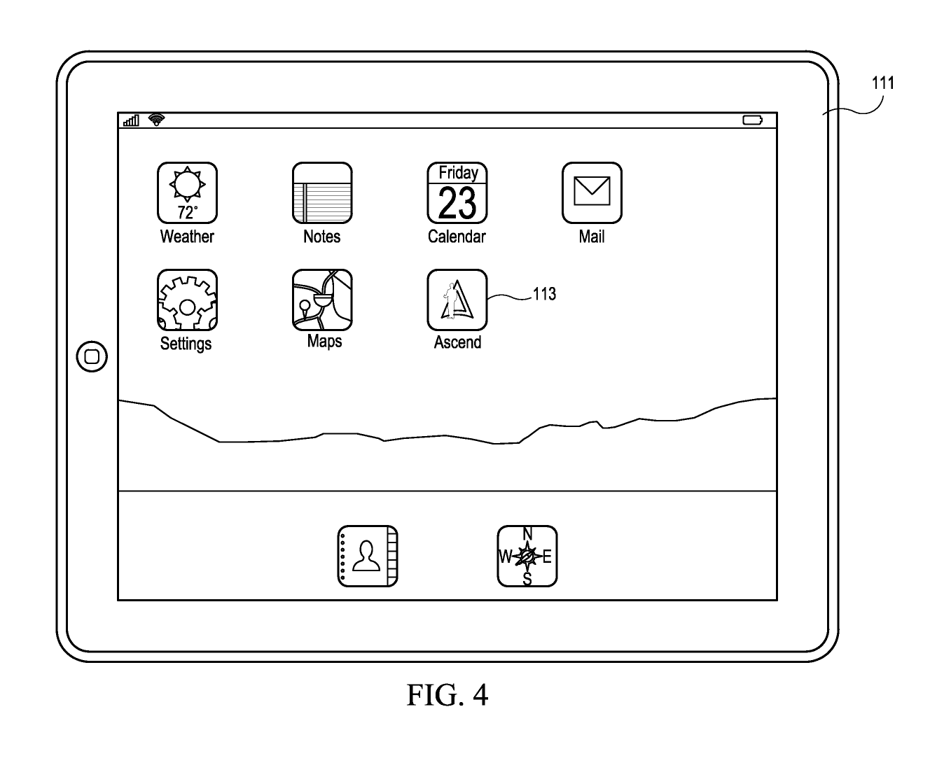

The portable wireless devices 111 can include, but are not limited to, handheld computing platforms having touchscreen technology, for example, an iPad® (trademark of Apple Inc., Cupertino, Calif.). The portable wireless devices 111 are specially programmed by mobile software application 113, which implements guided meeting process 200 (FIG. 3) and provides display screens which are intuitive to use with little to no instruction required, as illustrated in FIGS. 4-17. In one alternative embodiment, mobile application 113 is a webportal actively served by central data server 103 and displayed by portable wireless device 111.

To communicate with the central data system 101, the device 111 includes one or more communication devices 115 that provide one or more means of connecting with WAN 130, including for example, a cellular transceiver, a short-range wireless transceiver such as Bluetooth® (trademark of Bluetooth Special Interest Group of Kirkland, Wash.), and/or a wired networking device, with at least one of the devices preferred to be capable of a broadband connection and at least one of the devices capable of a wireless connection. The portable wireless devices 111 can also include a GPS receiver or other geographic locator 117 technology to provide the geographic location of a representative conducting an in-the-field meeting.

Monitoring Overview

The monitoring process 400, includes, for example, the steps of management 401 (e.g., using features of the management application 131 discussed below), lead generation 403 and lead distribution and appointment setting 405 (e.g., including using a commercially available client relationship management (CRM) application 132 that may be interfaced with or integrated into the system 100), initiating an in-the-field meeting 407, (e.g. including in-person insurance sales), collection of customer information 409 (e.g., including insurance quoting and enrollment information using mobile application 113 and a commercially available quote engine 133 that may be accessed or interfaced with or integrated into the system 100), central data collection 411 (e.g. transmitted using the mobile application 113 and centrally stored using the database 105 and the storage medium 107), analysis and reporting 413 (e.g., including compliance assurance), and quality management 415.

The mobile application 113 can be used to implement a guided meeting process 200 that can include protocol and checklist procedures and data checking during the meeting 407 in order to ensure compliance to non-regulatory requirements, for example policies, procedures, and best practices, and to regulatory requirements. These procedures and data checking can include, for example, verifying the proper product documents, features, pricing or other meeting content are used. For example, the proper and compliant meeting content for an insurance sale that is provided by a compliant entity 145, for example an insurance carrier, may be specific to a geographic location and/or demographic of the customer 143.

For meeting process 200, the mobile application 113 can guide each representative's meetings 407, including presentation of meeting content and collection of information, thereby ensuring compliance with regulatory requirements and/or non-regulatory best practices. Additionally, the mobile application 113 can inhibit selected steps of the meeting process 200 in the event an audit/compliance issue arises or is at risk if the process continues to the desired next step without first addressing the identified issue.

The system 100, including the mobile application 113, also develops a data set, for example including a audit trail, for some or all of the various steps of the process 400, including for management 401, lead distribution 403 and appointment setting 405, meeting process 200 steps associated with meeting 407, and collection of customer information 409, and central data collection 411. For example, the data set can relate to the customer information the representative 140 received, materials and other meeting content the representative presented to the customer 143, the geographic location of the meeting, etc.

Still referring to FIG. 2, the analysis and reporting step 413 implemented by the system 100 can include utilizing various compliance tools 150, for example including manual and/or software based processes used to screen and/or audit recordings (for example, digital audio recordings and/or processed transcription data) and/or data sets collected during each meeting process 200 with a customer 143. For example, quality monitoring or other auditing of recordings may include utilizing speech analytics 151, for example, by integrating tools such as those available from Nexidia, Inc., of Atlanta, Ga. The reporting and exceptions tool 153 analyzes data sets from various aspects of the monitoring process 400, including meeting information, customer information, data received from the speech analytics tool 151, and can be a manual and/or automated process, for example, using software.

The review of meeting audio recordings and data sets that takes place in the analysis and reporting step 413 facilitates quality management 415 and can be conducted in part or in whole by a third party service provider, or optionally, in part or in whole by the compliant entity 145, for example, one or more insurance carriers. For example, the analysis and reporting step 413 may identify exceptions, whether positive or negative, that relate to compliance, or may simply note features that indicate the representative 140 or particular sales activity should be more closely reviewed and analyzed. By identifying negative outliers, a possible elevated risk of noncompliance can be identified, and by identifying positive outliers, possible best practices by representatives can be identified and replicated throughout the sales force.

The step of quality management 415 may utilize a quality management application 155, and can include, for example, representative qualification monitoring and the ability to track outcomes for particular representative activities and/or events. For example, tracking outcomes can include a representative-to-representative pool comparison to determine comparative compliance, analysis and consideration of the activities for which representative retraining or additional training is required (remediation), analysis and consideration of the outcomes that suggest termination of a representative, and analysis and consideration of the activities for which best practices and compliance are being established or achieved and that should be rewarded and replicated.

Guided Meeting Process

Referring to FIG. 3 and the illustrative associated GUI layouts of the mobile application 113 (FIGS. 4-17), features of an illustrative guided meeting process 200 and the mobile application 113 that implements the meeting process 200 on portable wireless device 111 will now be discussed. Referring to FIG. 4, showing the desktop of a portable wireless device 111, the mobile application 113 in the illustrative system 100 is implemented as a software application downloaded to, stored on, and executed by the portable wireless device. Alternatively or additionally, the mobile application 113 could include some or all of its features implemented by a remote computer, such as the server computer 103, and accessed from the portable wireless device 111 via a web browser or other communication application.

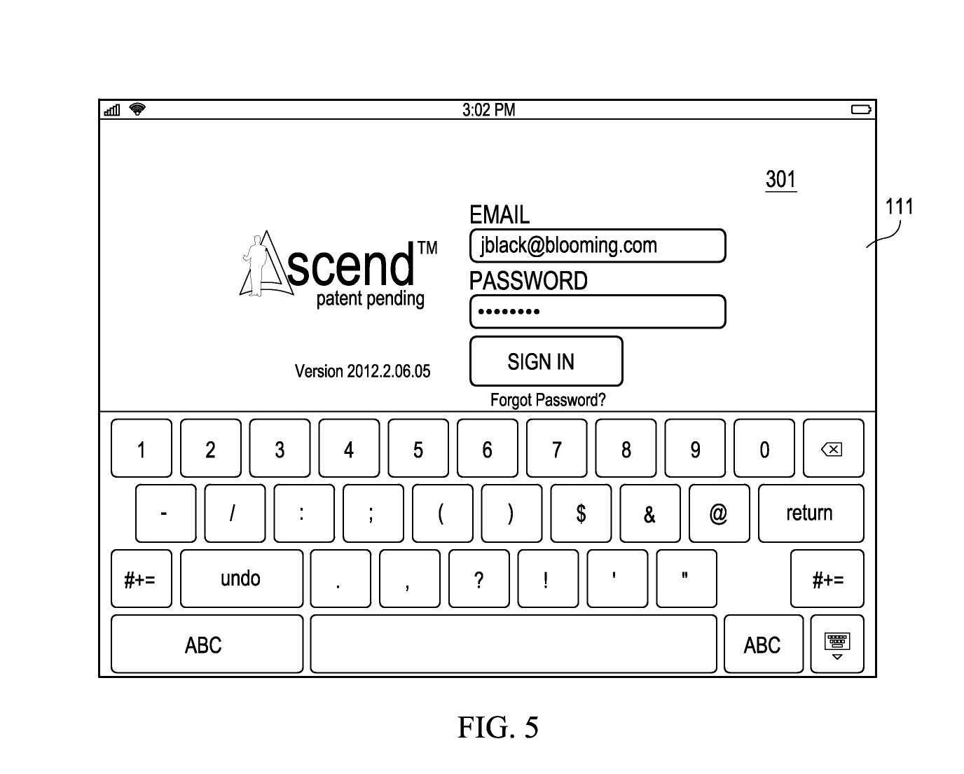

Referring to FIG. 5, showing a login screen 301 of the mobile application 113, upon login by the representative 140 at step 201 (FIG. 3), credentials of the logging in representative are checked by the service layer application 109, for example, which is associated with central server 103 and also implements data access security and license monitoring for the system 100. If valid, the service layer application 109 returns a time-limited access token for that specific representative 140 and the portable wireless device 111. The mobile application 113 stores the token on the portable wireless device 111 so that it can be reused for the authorized period of time. An unexpired token allows access to the remaining steps 202-231 of process 200 and communication with other components of the system 100, including central data system 101.

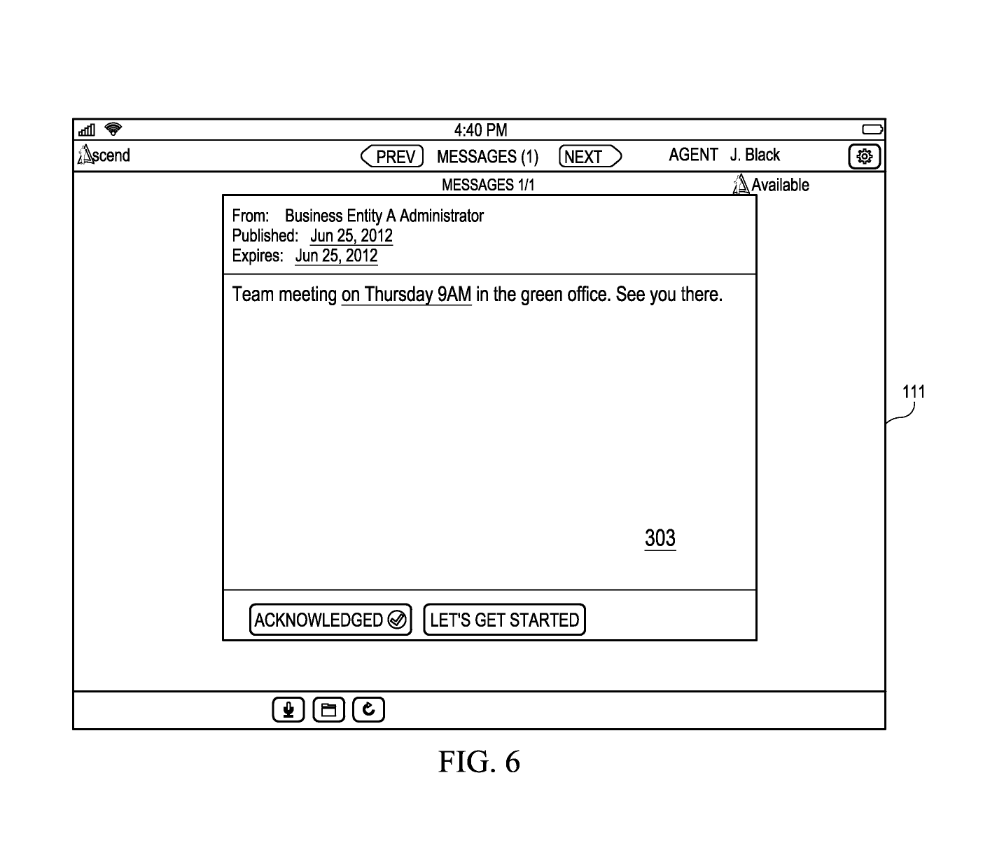

Referring to FIG. 6, showing a message screen 303 of the mobile application 113, the system 100 provides a message acknowledgment step 202 (FIG. 3) that downloads messages for the representative 140 from the central data system 101. Receipt of messages from the database 105 can be required to be manually acknowledged and/or automatically verified and reported to the central data system 101. For example, manual acknowledgement can be via the “Acknowledged” touchscreen softkey presented on the screen 303. The messages downloaded can include a date to publish, date to expire, associated receipt and acknowledgment statuses, and whether acknowledgment is required and will inhibit steps of the meeting process 200 if message is not yet acknowledged.

A meeting content distribution and updating step 203 (FIG. 3) provides automatic download from database 105 of up to date meeting content for use by the representative 140, including, for example, documents to show or provide to the customers 143. Receipt of such updated meeting content from the database 105 can be automatically verified and reported to the central data system 101. The meeting content downloaded can include a date to publish, date to expire, and associated acknowledgment status.

For example, downloading of messages and meeting content by the portable wireless device 111 from the database 105 via the service layer application 109 can be provided automatically by process 200 as soon as a representative 140 is logged in and has connectivity through WAN 130 to the central data system 101. Similarly, once the messages are viewed and acknowledged in step 202, a verification of acknowledgment can be automatically transmitted to database 105, thus developing an audit trail of compliance as part of the data set associated with the representative 140. The message screen 303 enables navigation through the messages. Optionally, the message screen 303 may provide reply, forwarding, and similar optional features common to electronic communication platforms.

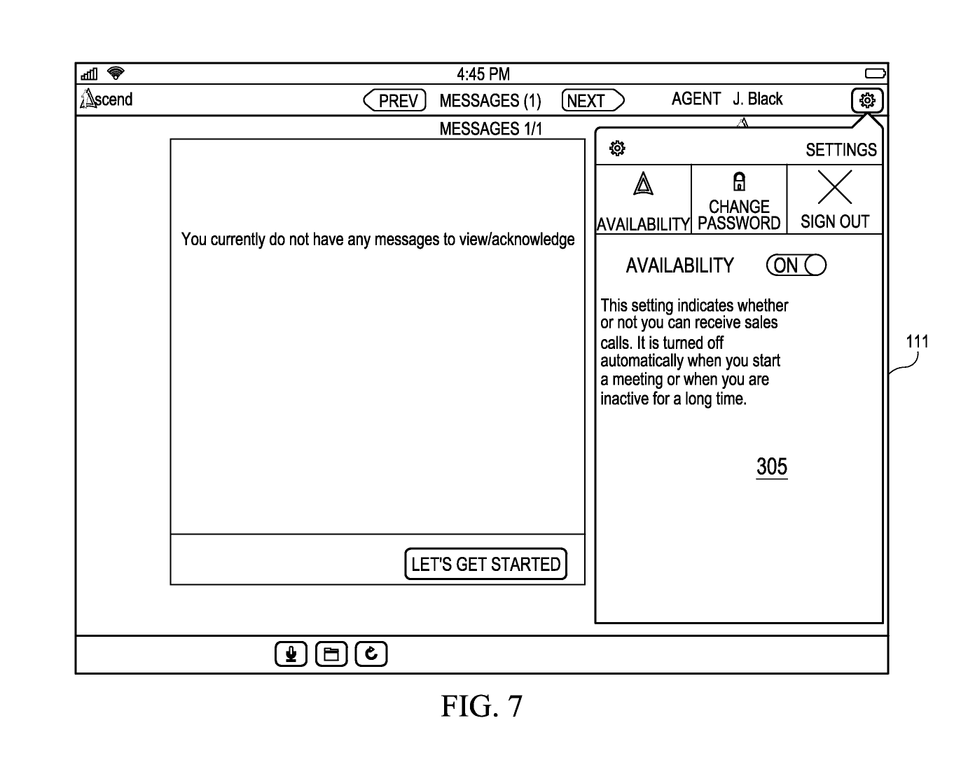

Referring to FIG. 7, showing an availability overlay (or drop-down menu) 305 of the mobile application 113, the step of updating the availability status and location 205 (FIG. 3) of representative 140 can include the representative setting availability information to be sent to the service layer application 109 and stored in the database 105. The representative 140 can set the availability status by utilizing a displayed softswitch such as that shown in overlay 305, and the availability status can include detail beyond just ‘yes’ or ‘no’, for example, ‘in a meeting’, ‘driving’, ‘gone home’, etc. Alternatively or additionally, the mobile application 113 can also set the availability status based on the representive's interaction with the application, for example, the representative initiating a meeting at step 211 discussed below. Such real-time availability information, optionally including geographic location, can be utilized, for example, by the management application 131, and/or the CRM application 132 to facilitate appointment setting 405 (FIG. 2). The availability overlay screen 305 also optionally provides other administrative functions for representative 140, for example, system sign out (log off) and changing the login password.

Referring to FIG. 3, in step 207 of the meeting process 200, the mobile application 113 can optionally enable the review, scheduling, rescheduling, canceling, and acceptance of appointments, and other tasks associated with customer relationship management for the representative 140, for example including interfacing with CRM application 132 via the service layer application 109. This integration and interfacing with the appointment setting step 405 and/or CRM application 132 can also be used in step 209 of the process 200 to obtain lead customer information needed for representative 140 to prepare for and/or schedule a meeting with a customer 143.

For example, the CRM application 132 can be used to launch the mobile application 113, passing lead customer information to the mobile application. Additionally, integration with a CRM application 132 can provide an end-to-end continuity of data and customer relations from first contact with a lead through the meeting and subsequent follow up. For example, in an insurance sales example, a customer lead may be initially qualified in a conversation with a call center agent 141 (FIG. 2) and desire to have an appointment for a meeting scheduled. In this case, the call center agent 141 can use the CRM application 132 to query the central data system 101 through the application service layer 109 for agents 140 within a selected radius of the customer 143 that have a present status of “available” selected, and who has any special skills or qualifications required, for example, a fluency in a particular language. The call center agent 141 can then conference in the field agent 140 so that the customer 143 can telephonically meet the agent to schedule the appointment. A unique scope of appointment identifier assigned at the time of the lead can then also be passed through the integration through all of the steps through submission of an application to the insurance carrier/compliant entity 145 and central storage of an audio recording and any other meeting and customer information.

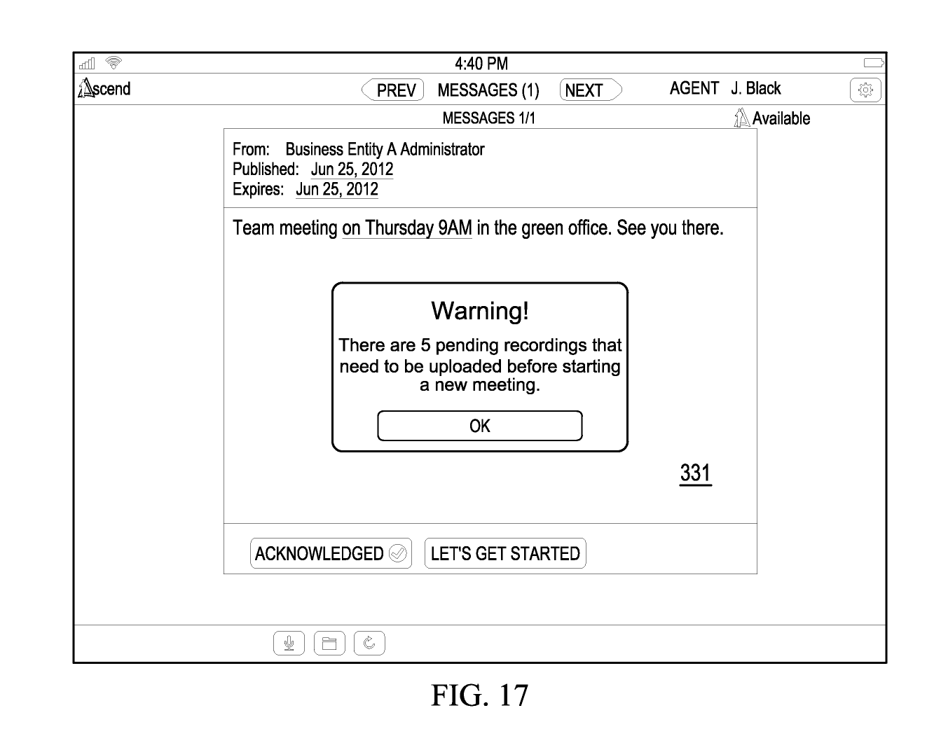

Referring again to FIG. 7, after the representative 140 has completed administrative functions, selecting the “Let's Get Started” touchscreen softkey presented on the screen 305 verifies that all received messages have been acknowledged, new or updated meeting content has been downloaded, and all information from prior meetings with customers 143 have been uploaded to the central data system 101, for example all audio recordings of meetings. If these acknowledgments, downloads, and uploads are not completed, the mobile application 113 may inhibit selected steps of the meeting process from being utilized until completed. For example, referring to FIG. 17, as shown in the meeting start blocked screen 331, further guided meetings, for example steps 211-227 of the meeting process 200, be inhibited by the mobile application 113 if greater than a preset limit of audio recordings associated with meetings are still stored locally on the portable wireless device 111 and have not yet been uploaded to the central data system 101. For example, disabling further guided and recorded meetings with customers if more than five sales calls have been recorded but not yet uploaded via a broadband network connection. Additionally, the management application 131 may selectively specify which ones of particular acknowledgments, downloads, and uploads inhibit which particular portions of the mobile application 113 until acknowledgment, download, or upload is completed.

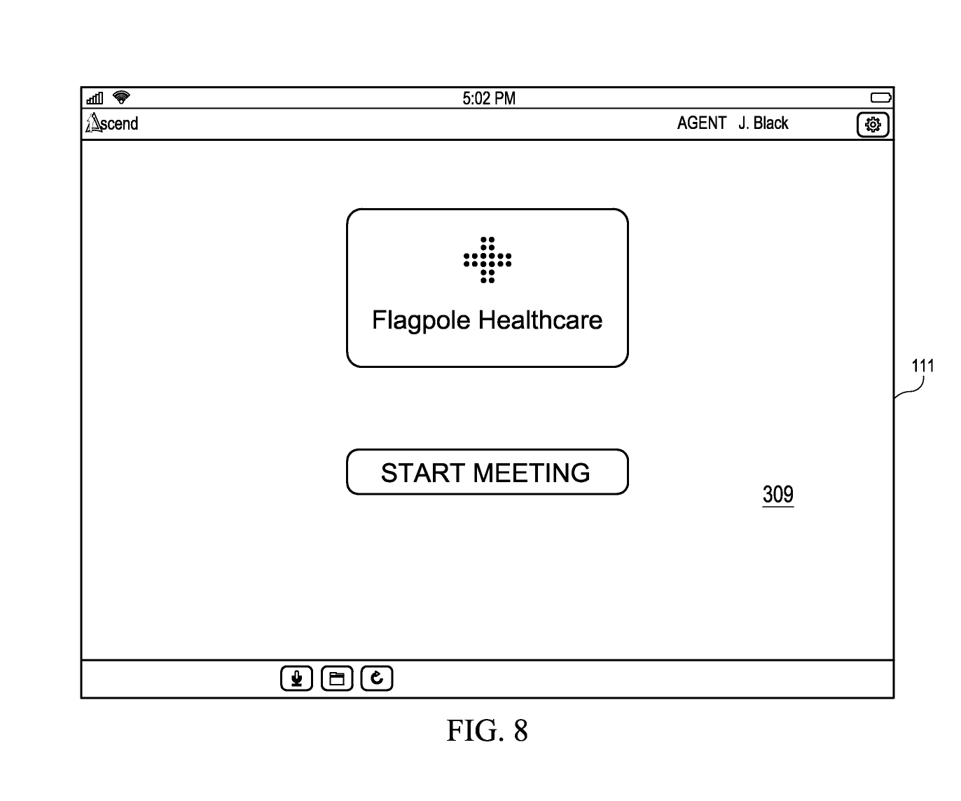

If the steps of the guided sales process 200 are not inhibited, then as shown in FIG. 8, a start meeting screen 309 of the mobile application 113 is displayed at step 211. The representative can start a meeting by selecting the touchscreen softkey “Start Meeting”. Upon initiating a meeting, the mobile application 113 can capture a start time and date and can utilize the geographic locator 117 of the portable wireless device 111 to capture the geographic location of the meeting. Alternatively or additionally, customer and/or meeting geographic information can be transmitted through the service layer application 109 to the database 105 at the time an appointment is selected, and/or at any later step of process 200 based on the geographic locator 117, or lead customer information, or other subsequent collected customer information.

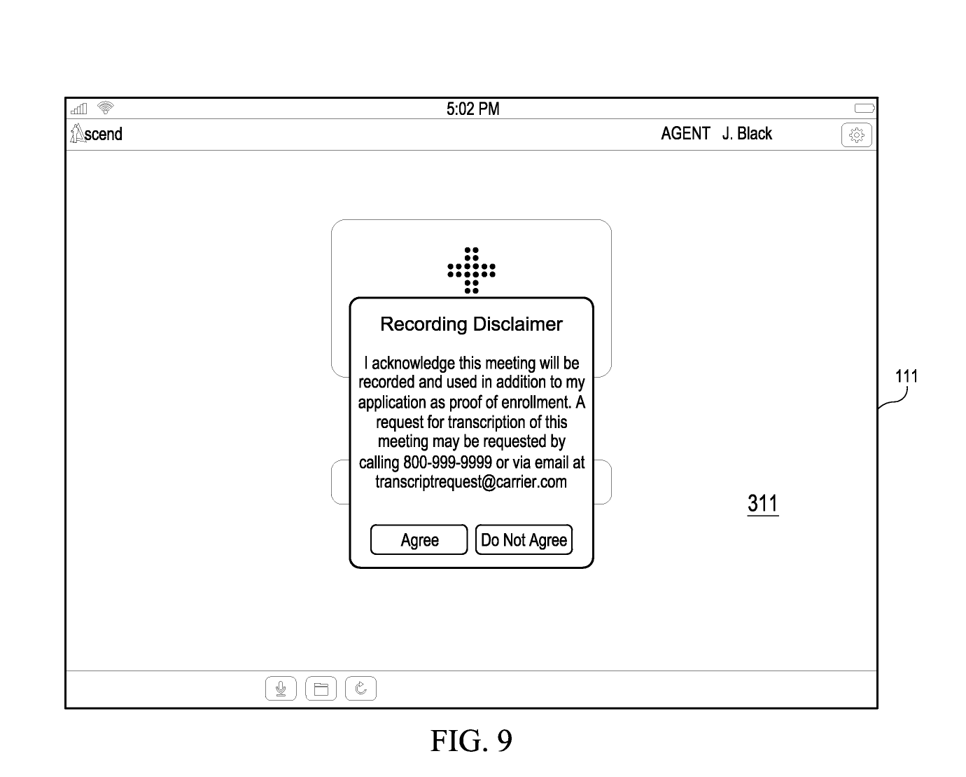

Referring to FIG. 9, showing the recording disclaimer screen 311 associated with mobile application 113, the step 213 of obtaining consent from customer 143 for audio recording of the meeting is facilitated, for example, by pressing the “Agree”, or “Do Not Agree” touchscreen softkeys below a Recording Disclaimer or Notice. Although audio recording of the meeting is preferred to facilitate the monitoring process 400, generally customers 143 can be given the option to decline recording if the subject matter of the meeting so allows or otherwise requires forgoing audio recording. The mobile application 113 then initiates or forgoes audio recording using a microphone input (not shown) associated with the portable wireless device 111

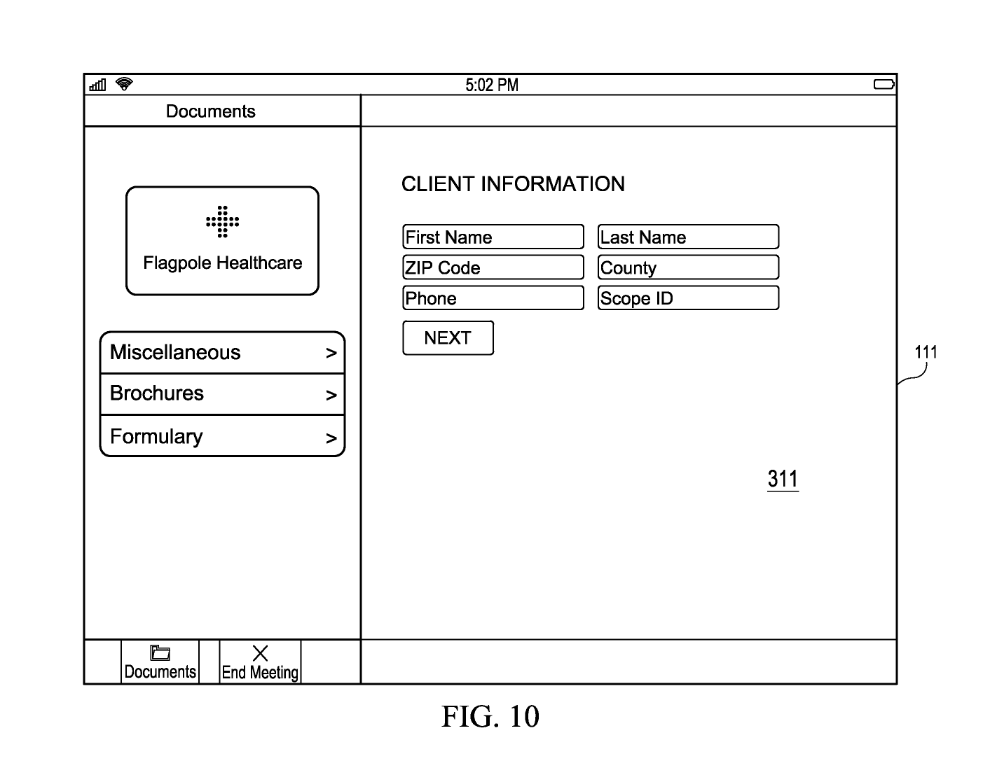

Referring to FIG. 10, a meeting content menu is shown on the left portion of screen 311 and basic customer information form is shown on the right portion of the screen. Generally a meeting with a customer 143 begins with or quickly requires obtaining some basic customer information, for example including name, address, zip code, phone, and county. Such information may have been obtained by the mobile application 113 and auto-filled in screen 311 by the representative selecting a saved customer contact or accepting an appointment, either via an appointment message or by integration with CRM application 132, which may also provide a scope of appointments identification number unique to that meeting. Integration allowing the mobile application 113 to interact with, launch, be launched by, and exchange data with a CRM application 132 (or other applications that are remote or located on the portable wireless device 111) can be implemented using an API, User Interface Handler, a HTTP post data key value pairs, or other methods known in the art.

After obtaining and verifying basic customer information, the representative selects the “NEXT” touchscreen softkey to proceed to step 217 and present meeting content, which may also involve the representative and/or customer 143 viewing, listening to, and/or interacting with meeting content, for example, including selecting among various choices or the collection of additional customer information. On the left side of the illustrative screen 311 shown in FIG. 10, a navigation window to access meeting content, including documents, is shown. Additionally, the mobile application 113 in conjunction with the central data system 101, can tailor the specific meeting content that is made available and presented in each meeting based on the customer information obtained prior to and/or during the meeting process 200. Meeting content can include, but is not limited to, text, graphics, documents, video, audio, interactive processes, web portals, and other materials that facilitate the collection or sharing of information.

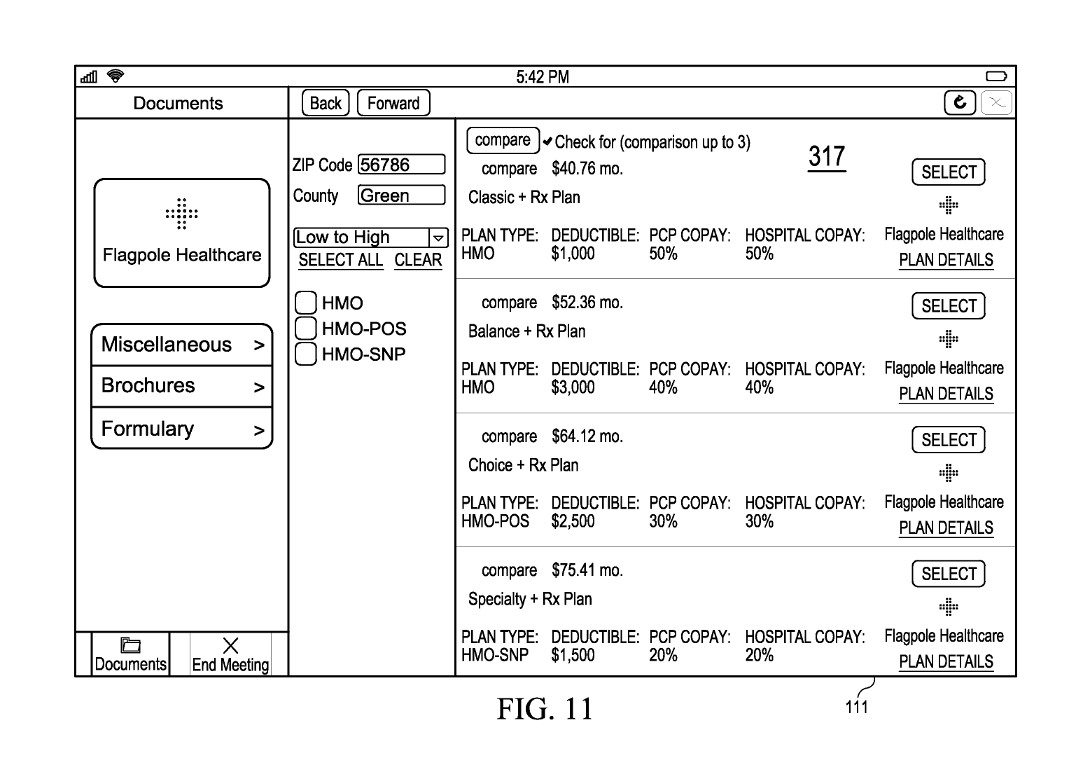

For example, referring to FIG. 11, in the context of a meeting involving the representative 140 offering and selling insurance products to the customer 143, generally a needs analysis is first completed with a customer 143 and then a quotations for various plans are presented, as shown in the plan listing screen 317. For example, the customer's current circumstances, coverage, coverage gaps or concerns, and additional needs, helping to guide the products included and displayed in the plan listing screen 317. Additionally, customer information used to select and quote costs for various plans may include geographic information, such as zip code or county, and basic health questions, for example, smoker/non-smoker status, age, gender, and special health needs such as dialysis treatment.

The customer information is then processed by a quote engine 133 (FIG. 2) or other software tool. For example, an insurance carrier's existing quote engine can be accessed to process the information, or a quote engine available from Bloom Insurance Agency of Bloomington, Ind. can be utilized. For example, the quote engine can be accessed through the service layer application 109 and located on the server computer 103, another remote computer, or on the portable wireless device 111. For example, the right side layout of the screen 317 in FIG. 11 can be provided as a window, for example a web portal, having meeting content generated by a quote engine 133 residing on a remote computer server of a third party, for example, the compliant entity 145. Information can be passed between such a quote engine 133 or other application and the mobile application 113 using HTTP post data key value pairs or other methods known in the art.

The quote engine 133 is used to develop and modify a list of available plans and other details that address the needs of the specific customer, for example, as shown in plan listing screen 317 associated with the mobile application 113. Additionally, the plan listing can be modified by selecting various sorting and/or filtering preferences regarding aspects of each plan. For example, such aspects of plans that could be used to sort/filter include type of health plan, desired annual deductible amounts, budgetary constraints, preferred doctor in network, and prescription drug coverage included or not.

As shown for the plan listing screen 317, for each available plan, basic information is provided and additional, more detailed plan information can be navigated too. For example, up to date meeting content providing more detailed plan information can be selected and viewed from a list by selecting “PLAN DETAILS” associated with a particular plan. If a device for printing is available at the meeting, such meeting content can then be printed, if desired, or emailed or otherwise provided to the customer 143. Lastly, particular plans on the listing can be selected, for example by checking a box next to the plan identifier, as shown in the plan listing screen 317 of FIG. 11, and “Compare” can be selected in order for the customer 143 to see a feature by feature comparison of the selected plans.

The listing of documents can be, for example, any documents that the insurance carrier (compliant entity) 145 carrier uploads and associates with a given plan. For example, the carrier will identify and upload documents that are needed for the representative's reference or needed to present to the customer and provide more information about a specific plan during the meeting. Advantageously, a selected document can be opened in a window overlaying the present window so that navigation between plans in the plan listing screen 317 is not lost.

After presentation of possible plans, and associated information, a particular plan can be selected by the customer for enrollment. Such a selection can simply be made on the plan listing screen 317 using a soft button associated with that plan, for example labeled “SELECT” as shown in FIG. 11.

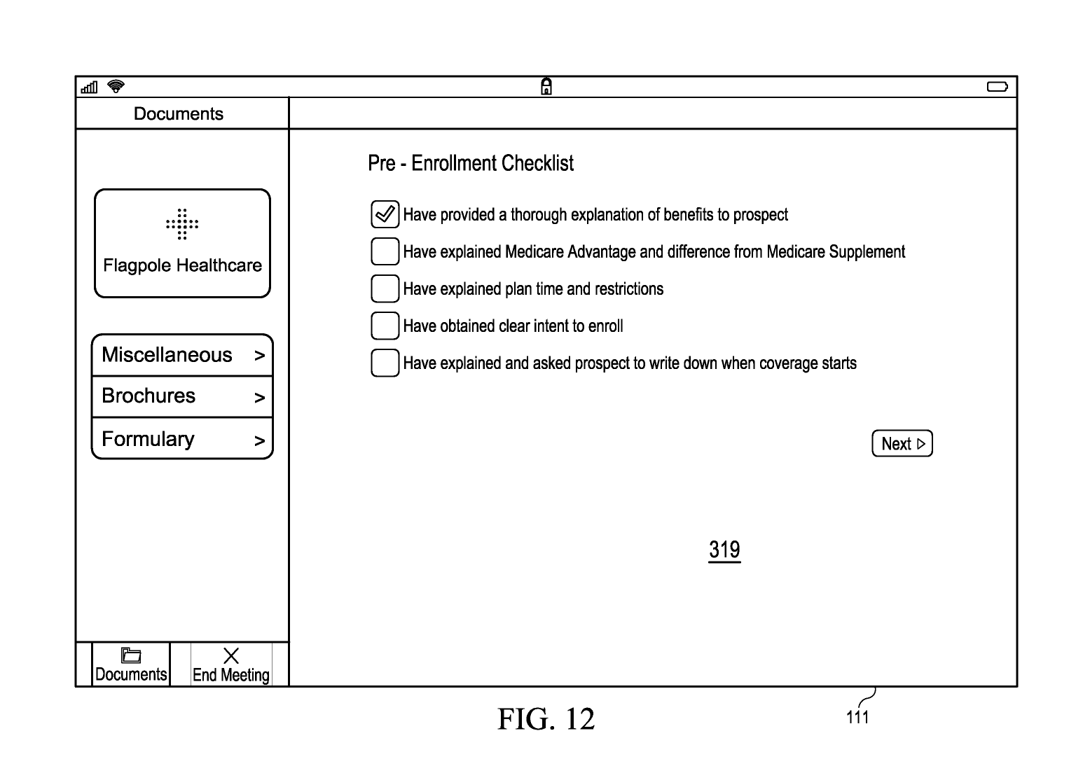

Referring to FIG. 12, the mobile application 113 can provide an interactive checklist step 225 (FIG. 3) that the representative 140 or, alternatively or additionally, the customer 143 must acknowledge before the proceeding in the process 200, for example, as shown in the illustrative pre-enrollment checklist screen 319 (FIG. 12). Alternatively, such checklist steps can be inherent in the material content for which navigation and presentation is forced through by the mobile application 113.

Such a checklist forced navigation can be used to verify that all steps, such as disclosures necessary for regulatory and non-regulatory compliance, are completed before the meeting is concluded or some other action, for example actual enrollment (submission of an insurance application) is made. For example, such required disclosures may include explaining and understanding the difference between various products, for example, between Medicare Advantage and Medicare Supplement, providing information about prescription drug coverage, if any, disclosing premiums required, if any, and determining whether a particular healthcare provider preferred by the customer is available under a specific plan.

In one embodiment, as shown in FIG. 12, the checklist screen 319 is interactive in that it is presented as a list with open boxes that must be selected on the touchscreen to check each item as complete, thus acknowledging that a particular disclosure or other pre-enrollment step was completed, and the data from this acknowledgment is transmitted to the database 105. Furthermore, the use of checklists can ensure that policies, procedures, and best practices are followed by the mobile application 113 forcing and validating all steps and intermediate steps in the sales and enrollment process 200, thus ensuring compliant workflow and resulting meeting content and data.

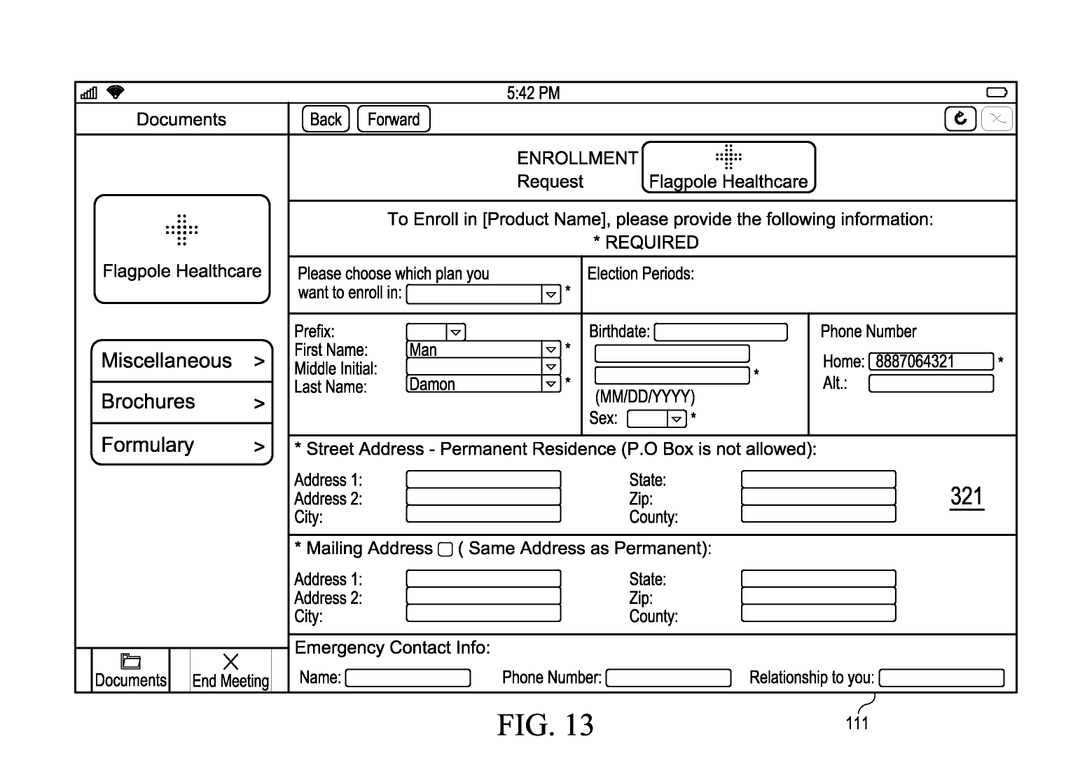

Referring to FIG. 3, additional customer information can be collected at step 221, for example, via an illustrative enrollment information screen 321 shown in FIG. 13. Additional customer information can be collecting using the touchscreen, audio inputs, swipe card readers, data port, communications device(s) 115, or any other interface in the art and associated with the mobile application 113. Subsequent or concurrent with step 221, data checking in step 223 may be implemented by the mobile application 113, or may be a separate, but integrated software component that resides on the portable wireless device 111, or resides at central data system 101 or another remote computing device, and that is accessed over the WAN 130. Thus, pre-existing enrollment software or software applicable to meetings for other industries can be integrated into the process implemented by the present system 100. For example, as with step 217 above, the right side layout of the screen 321 in FIG. 13 can be provided as a window, for example a web portal, having meeting content generated by an application or webserver residing on a remote computer server of a third party, for example, the compliant entity 145. Information can be passed between such a quote engine 133 or other application and the mobile application 113 using HTTP post data key value pairs or other methods known in the art. Advantageously, sensitive customer information that is collected can be transmitted to the compliant entity 145, or collected by their application provided in the window of screen 321 so that the information is never collected or stored by the portable wireless device 111 or central data system 131.

Data checking of customer information collected via the portable wireless device 111 and mobile application 113 is completed, either interactively during the steps 221 and 223, or upon completion of the process 200. Data checking can vary, for example, based on what information is critical and what information that is more often incomplete or in error and able to be checked. Such data may include, for example, information collected during the collection of basic customer information in step 215, during the presentation of meeting content 217, as well as additional customer information collected step 221. For example, such information can be verified to ensure the data is collected, and that the data meets various criteria, including, for example, that particular health criteria for the selected insurance product are satisfied, that name and address are filled in, and that the correct number of digits are present for zip code, that the address and zip code information is valid based on the USPS address validation API (application program interface), phone number, and social security number. Data checking can be completed by the mobile application 113, management application 131, a third-party application such as the quote engine 133, or a combination of these components.

Following completion of other meeting steps, the meeting content presented can include a thank you, an enrollment ID, information about when the customer will receive further information, and what information will be forthcoming, or any other information the customer may need until the enrollment application if processed and further confirmation is provided to the customer by other means. The final meeting content can also be provided in other forms, for example, by hardcopy if printing equipment is available, or by email or other electronic or non-electronic means.

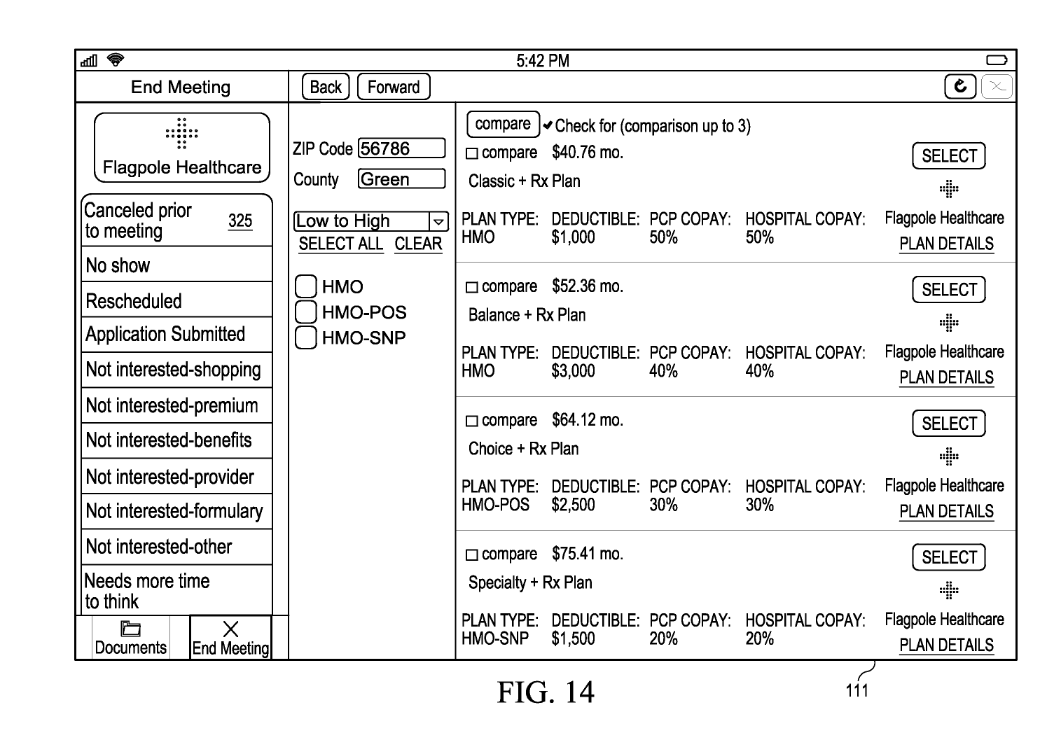

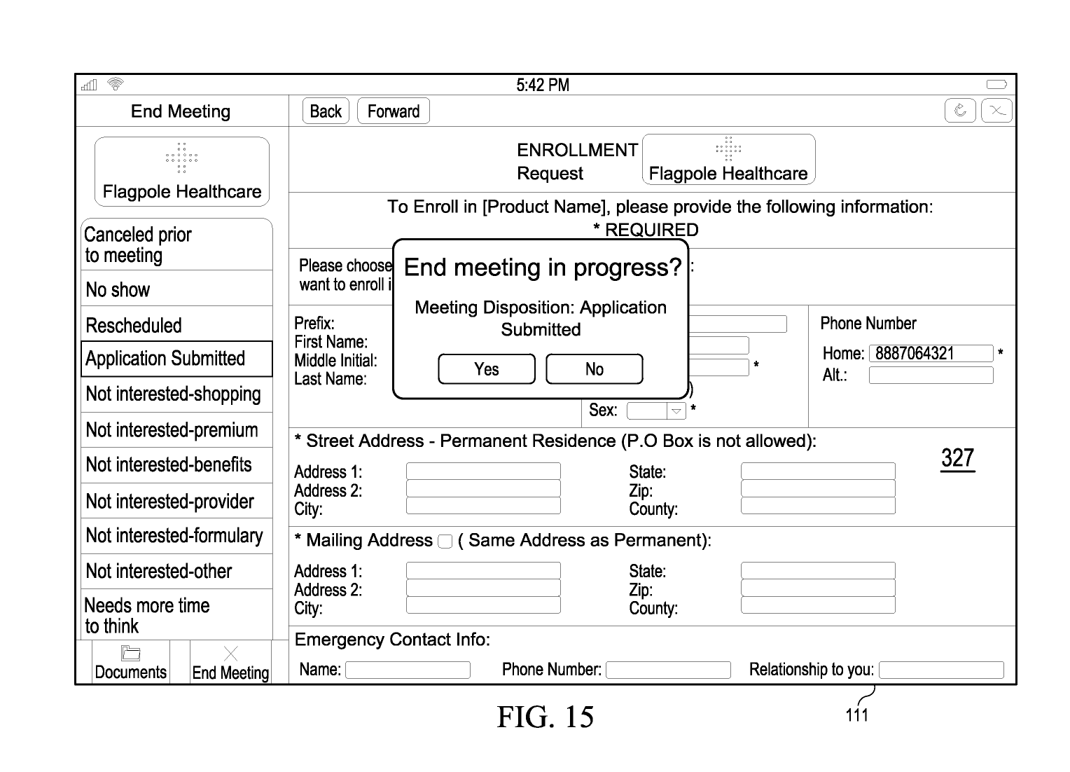

Following successful completion of the meeting, the mobile application 113 can store all meeting and customer information for transmission to the central data system 101. Referring to FIG. 14, next, the representative 140 at step 229 selects “End Meeting” to close out the meeting guidance for that meeting. The duration, meeting end time and date, and the disposition of the meeting step 227 can then be automatically generated based on the information collected, or can be specified by the representative. For example, as shown in FIG. 14, on the disposition screen 325, the representative 140 can select from a menu of typical choices to report on the outcome of the sales call, for example, “Cancelled prior to meeting”, “No show”, “Rescheduled”, “Application Submitted”, “Not interested—(reason)”, and “Needs more time to think”. Additionally, the representative 140 can provide sales activity notes or specific follow-up or rescheduling information that are made available for data reporting and to the CRM software 132 and/or the compliant entity 145. Once a meeting disposition is selected, an end meeting verification screen 327 (FIG. 15) is presented at step 229 to verify the representative's choice.

After the meeting is ended, audio recording is ceased and if a connection of sufficient to WAN 130 is available, the automatic transmission of data step 231 transmits the customer and meeting information (data set) from the mobile application 113, through the service layer application 109, and to the central data system database 105 and storage medium 107. If a connection of sufficient to WAN 130 is not available, the transmission of data step 231 is delayed, for example, until the end of the day when the representative has such access. The data set may include, for example, the geographic location, the audio recording, customer information, meeting content (including documents) presented, checklist completion data, enrollment information, disposition data, and other meeting information. Additionally, regardless of whether the mobile application 113 was launched using an integration with a CRM application 132 or other application, the meeting process 200 can launch or otherwise pass data to a CRM application 132 (or other applications that are remote or located on the portable wireless device 111) at step 231, including using an API, User Interface Handler, a HTTP post data key value pairs, or other methods known in the art.

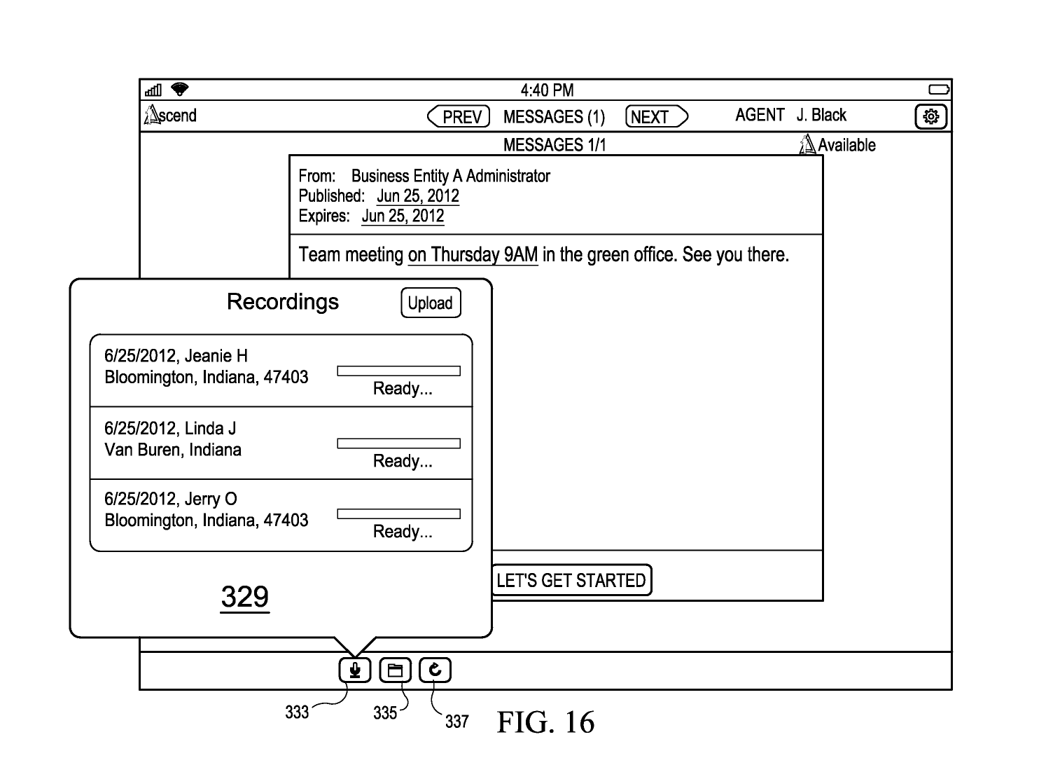

Additionally or alternatively, a portion of the data set and recording associated with an individual meeting process 200, or all the data sets and recordings for all sales activity, can be manually uploaded by selection of the microphone icon 333 and subsequently the “Upload” softkey on the upload screen overlay 329 of the mobile application 113, as shown in FIG. 16. The two other icons shown adjacent microphone icon 333, are a folder icon 335 for accessing documents and other meeting content, and a message refresh icon 337 for downloading an newly available messages from the central data system 101.

The service layer application 109 provides interaction between the mobile application 113, the management application 131 and associated management application 131, the database 105, and the storage medium 107. The service layer application 109 provides security as well as the communication between the components of the system. Security includes authentication and limitations that protect personal health information (PHI) and other sensitive data in the system. For example, the service layer application 109 can limit the amount of PHI that can be stored on a portable wireless device 111 before uploading transmits the data sets and recordings to the database 105 and/or the storage medium 107. Additionally or alternatively, client and meeting information can be uploaded to a third-party storage device, for example, one associated with the compliant entity 145. The uploading process can also remove at least the audio recordings and sensitive portions of the data sets from the device 111. In addition to authentication and security, the service layer application 109 can be used to control licensing (e.g., one login per representative at a time, regardless of device used) and to provide a local cache accessible with the time limited token at mobile application 113, for example, at times that communication between the portable wireless device and the central data system 101 is not available.

Because communication may be limited in bandwidth at times and places, or in some cases, the WAN 130 may be unavailable, the token received upon the login step 201 may be set to expire after a suitable delay for the circumstances, for example, one day or a few days after it is issued. As long as the token is unexpired, various features provided by the mobile application 113 on the portable wireless device 111 can be enabled, even if connectivity between the central data system 101 and the portable wireless device 111 is not available at a particular sales location. For example, in order to facilitate such “offline” meetings, downloaded meeting content, messages, checklists, and any other data required for certain sales activity and use of the mobile application 113 will be cached on the portable wireless device 111 so that they are available for use. For example, use of central features such as a quote engine 133 may be hosted in part by the central data system 101, and therefore require connectivity with the central data system and not be available without availability of the WAN 130; however, other guided meeting process steps and meeting content presentation and collection of information on device 111 can be enabled by the mobile application 113 so long as the token is unexpired.

Additionally or alternatively, even in the event that WAN 130 or another higher speed broadband connection are not available, for example, only a basic cellular network connection is available, certain meeting activity, local audio recording, and limited data exchange to support that activity may be enabled by mobile application 113 and an unexpired token on device 111. For example, in such a circumstance, reporting of the disposition of a meeting may be uploaded to central data system 101 over a slower communication connection, but the full data reporting and audio recording upload of a meeting may not be available until a broadband connection is available, and similarly, if an updated mobile application 113 is available, it may not be available for download to the device 11 until a broadband connection is available.

For example, upon login over a Wi-Fi® (trademark of the Wi-Fi Alliance, Austin Tex.) or other broadband connection at the beginning of a work day, and/or, end of a work day, a fresh token can be obtained and any meeting content, audio recordings, and other data that are potentially large files can be uploaded or downloaded. For example, updated meeting content can be downloaded from the central data system 101, and audio recordings from sales calls can be uploaded to the data storage medium 107. Optionally, such content downloads and audio recording uploads may be disabled if connectivity is at a lower bandwidth, for example 3G cellular connectivity, but download and upload can be enabled automatically for a higher bandwidth, for example, over a broadband network connection.

When connectivity of any bandwidth is available, transmission of particular messages and information can be selectively available as desired and implemented by the system 100. For example, all messages of a particular urgency, or alternatively all new messages, may be presented anytime a representative logs in and any connectivity is available.

Management

The administrative component of the system 100 includes management application 131 that provides real-time management (RTM) of meeting content and workflow, either at the central data system 101, or by logging into the management application 131 using a remote terminal 123. The management application 131 can mirror selected or all of the functionality of the above described functionality available using the mobile application 113 and may be implemented to include a local program component, management interface 121, on computing device 123 (which could include the portable wireless devices 111) and/or a hosted program component that is accessed by a browser or other remote access interface from computing devices 123. Additionally, the management application 131 also enables the administrator 124, for example, the compliant entity 145 and/or a service vendor (not shown) to administrate the system 100, including the processes 200 and 400, including the analysis and reporting of compliance step 413.

The management application 131 component also enables the management step 401 of the monitoring process 400, including transmittal, and optionally creation, of meeting content and messages, ultimately to the appropriate representatives 140 via the portable wireless devices 111, thus ensuring the latest information is timely and fully distributed to representatives, receipt is acknowledged, and old meeting content and messages that are no longer applicable are removed from service, including automatically removing such old meeting content and messages from viewing or other access on the portable wireless devices 111 using the mobile application 113, either based on a expiration date, replacement with an updated, or withdrawal of the content or message.

In a deployment of system 100 in the insurance industry, new or revised meeting content and messages uploaded to the database 105 via the management application 131 for confirmed distribution to representatives 140 may include, for example, insurance plan details as well as resources such as needs analysis worksheets or checklists, including scripts or data automating marketing and sales steps of guided meeting process 200 enabled by the mobile application 113 running on the portable wire devices 111. The management application 131 can also enable creation and transmittal of meeting content and messages to the customers 143, for example, enrollment documents discussed above. The management application 131 can also be used to provide an updated version of management application 131 the implements monitoring, compliance, or other changes to the system 100.

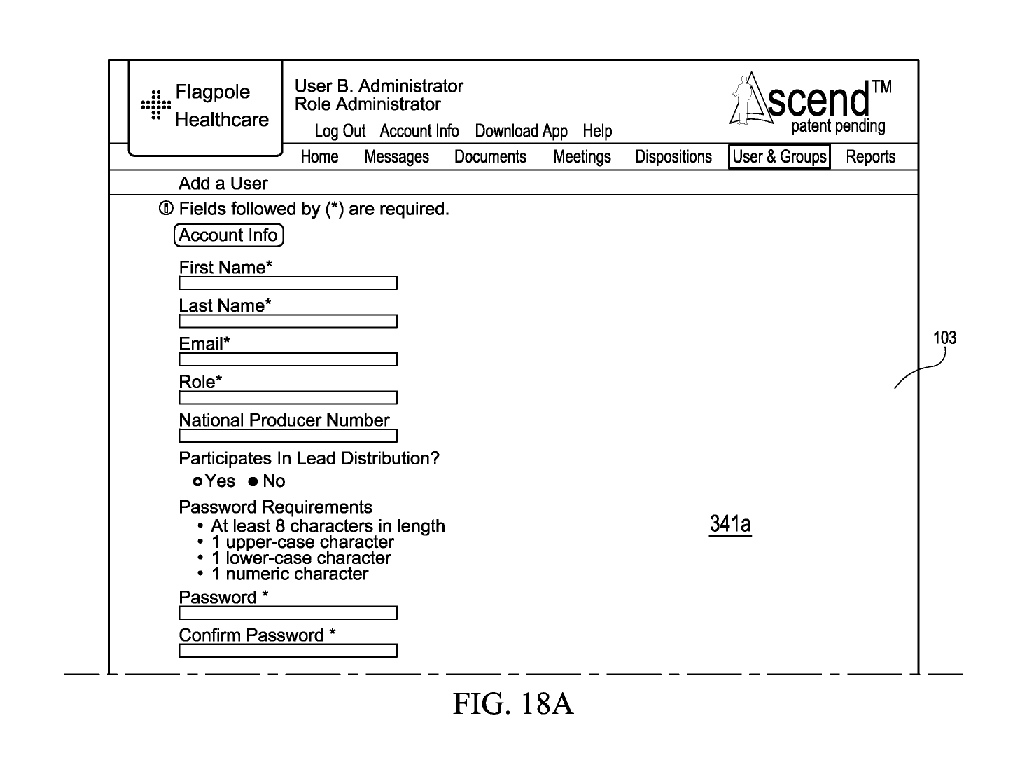

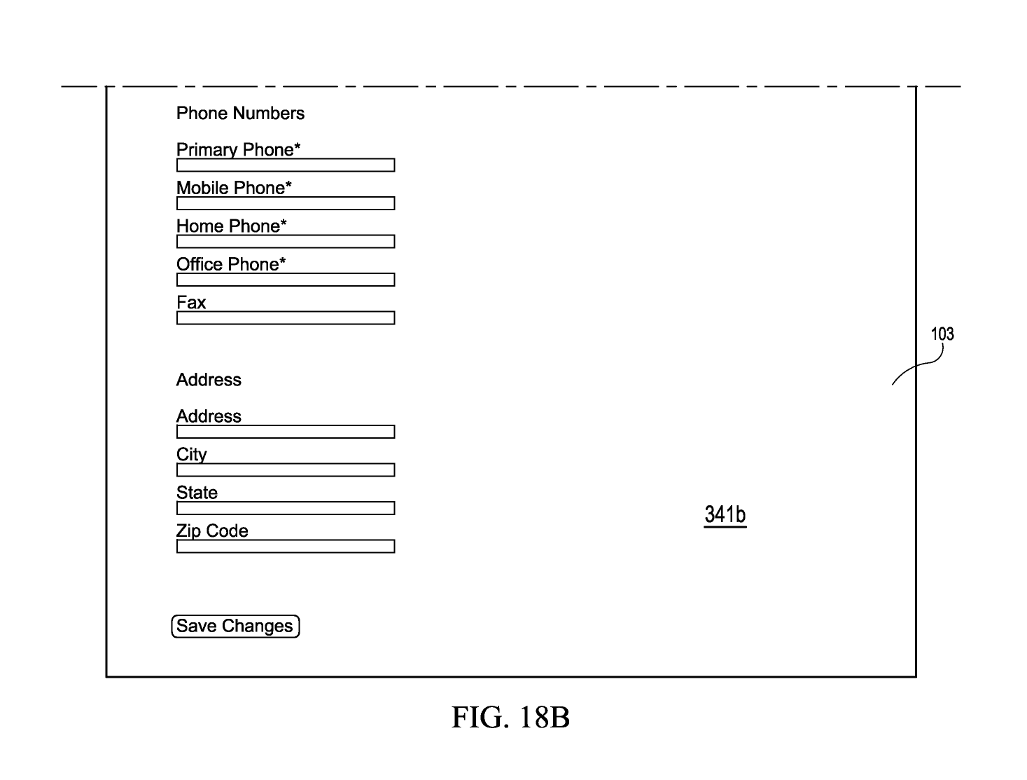

As shown in the illustrative GUI and report layouts of FIGS. 18A-25 and 27-40 associated with the management application 131, the application can be used to create, group, and assign roles to individuals associated with the monitoring process 400, to enable creation and distribution management of various meeting content (including documents) and messages, to search and review meeting information and client information, and to monitor representatives using historical and real-time reports relating to meetings and other activity and relating to exceptions and other compliance related analysis. Each of the various GUI and report layouts can include selectable data searching and/or filtering fields as can been noted in the illustrative layouts FIGS. 18A-25 and 27-40. Additionally, the various GUI and report layouts can allow a click-through of various information displayed that proves a different or more detailed presentation of the information selected.

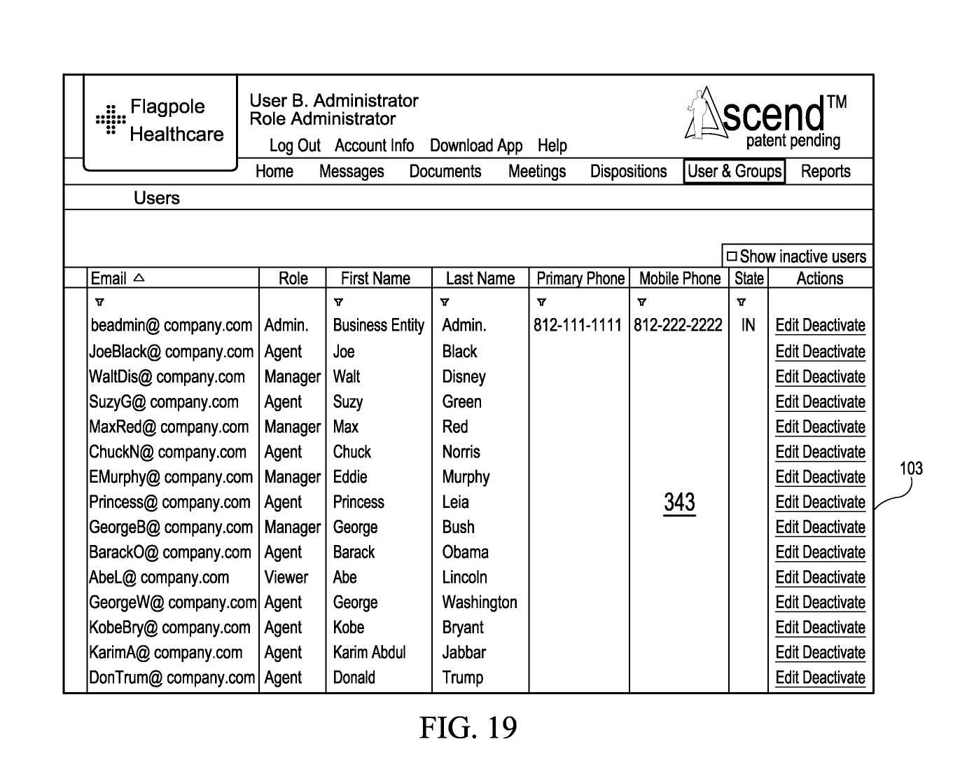

FIGS. 18A and 18B are the upper and lower partial views of an illustrative screen layout 341a and 341b for adding a new user associated with the system 100, including new representatives 140. FIG. 19 is an illustrative screen layout 343 listing the user information. Both layouts 341a/b and 343 are implemented by the management application 131. The user information can include one or more assigned roles for each individual specifying how they may interact with the monitoring process 400. Example roles include representative (including agent), viewer, manager, compliance, and administrator. The roles can be used to define the scope of access provided to various features of the system 100 and monitoring process 400, including to meeting process 200 and to data stored in the central data system 101, and whether such access allows viewing, editing, creation, deletion, and the like of data, audio recordings, analysis, and reports.

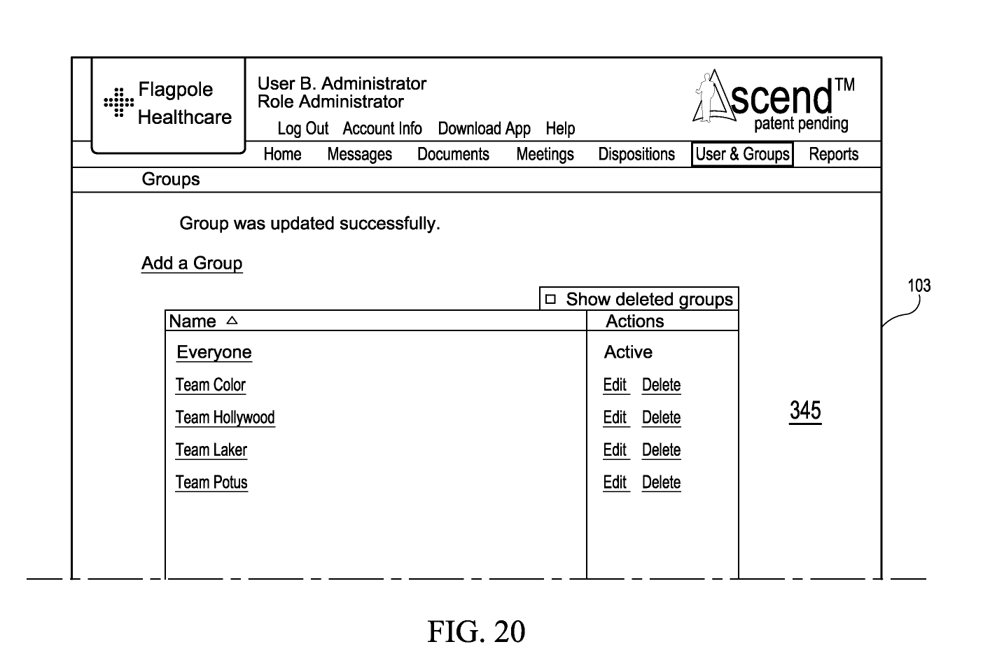

FIG. 20 is a illustrative group screen layout 345 providing a group listing associated with a group management feature of the management application 131. Logical groups or other logical relationships can be specified to manage various aspects of the system 100, monitoring process 400, and users (including representatives 140), including grouping representatives that receive a particular document or have particular access or sales privileges. Thus, for example, the representatives 140 can be included in more than one group. For example, representatives 140 may belong to one group based on their common role assigned, another group based on the geographic region they serve, another based on special qualifications, skills, licensing, or other attributes that differentiate individual representatives. For example, for the insurance industry, one group may be defined for all representatives 140 associated with a particular agency, and another group be defined as all of the agency groups associated with a particular insurance carrier.

Such grouping can assist in the correct distribution of meeting content and messages, developing specific reports, scheduling a representative 140 to meeting with a specific client 143, and with other features of the system 100. For example, language fluency may be a skill that is associated with a specific group or noted in another logical data element for each representative 140.

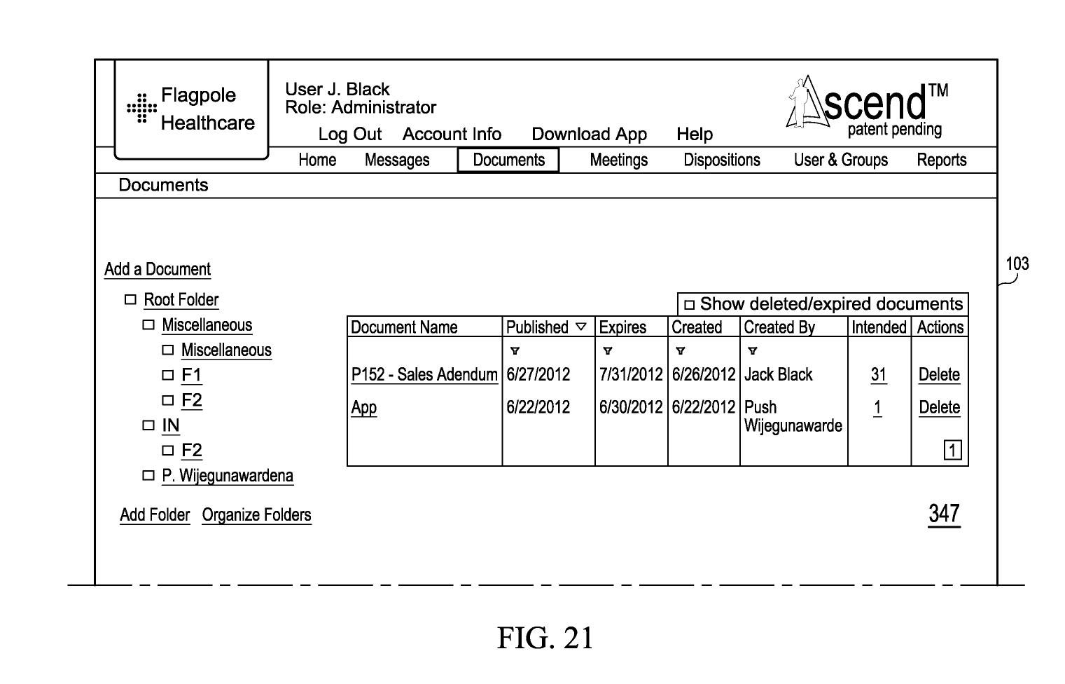

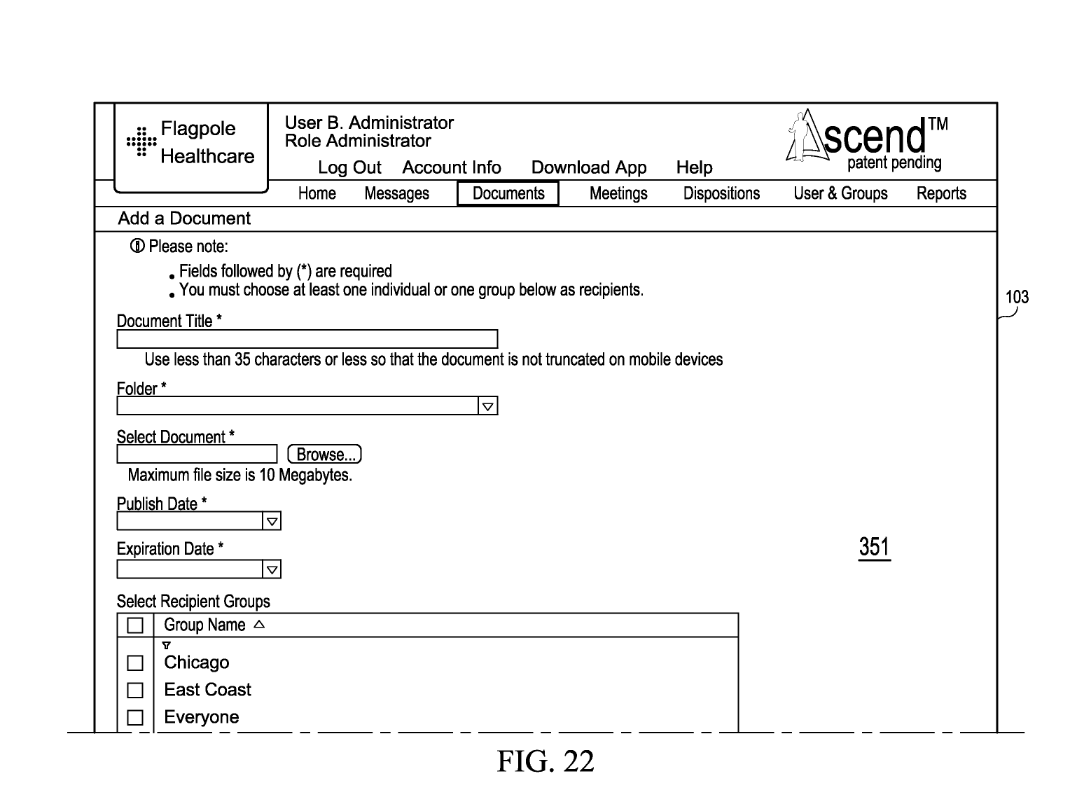

Additionally, the management application 131 can be used to create and manage meeting content and messages, including, for example, specifying to send a particular document or message to one or many representatives 140 or one or many groups. For example, FIG. 21 shows an illustrative screen layout 347 for meeting content management, including management of documents and a hierarchy of meeting content folders. Each document (or other meeting content) can include publication, expiration, and creation dates, creating user, and intended recipients. FIG. 22 shows an illustrative screen plan 351 for meeting content creation and editing, for example, creating a document, and for specifying recipients and other features of the meeting content.

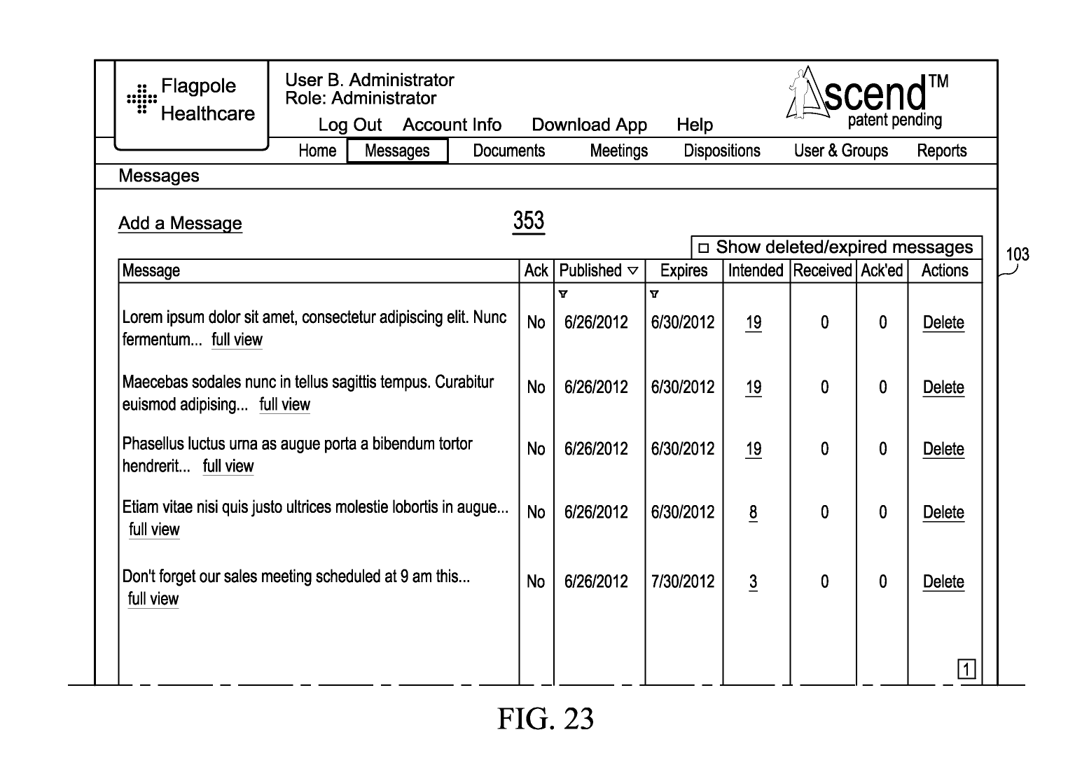

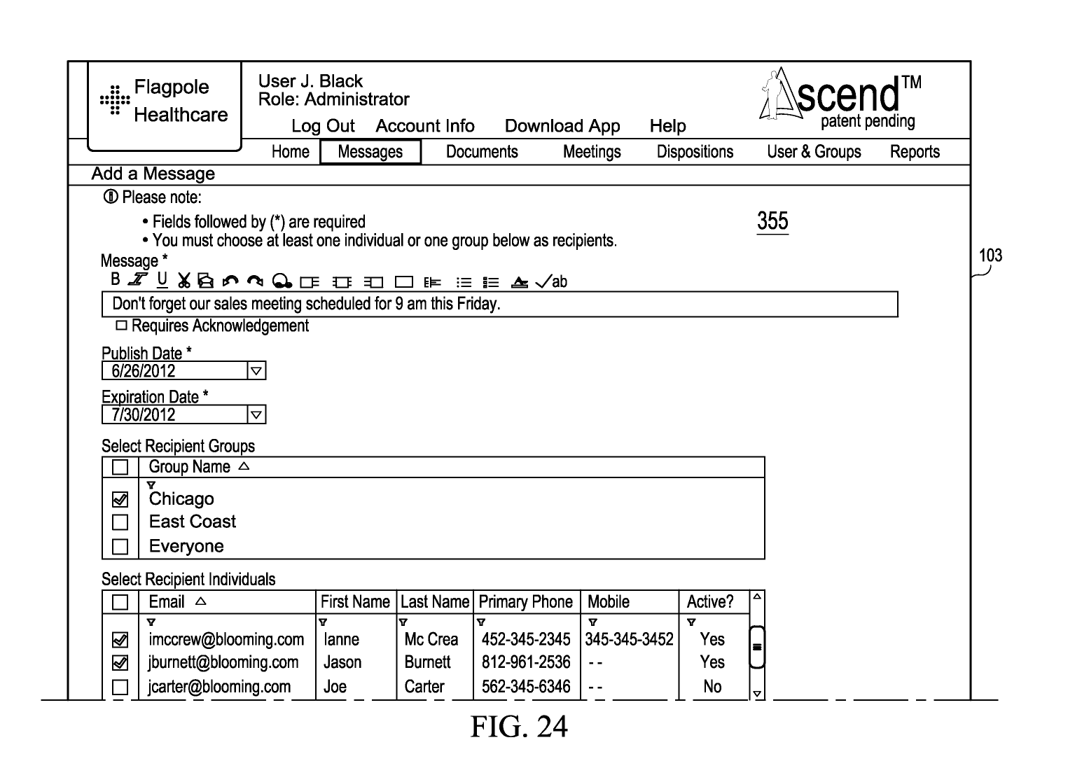

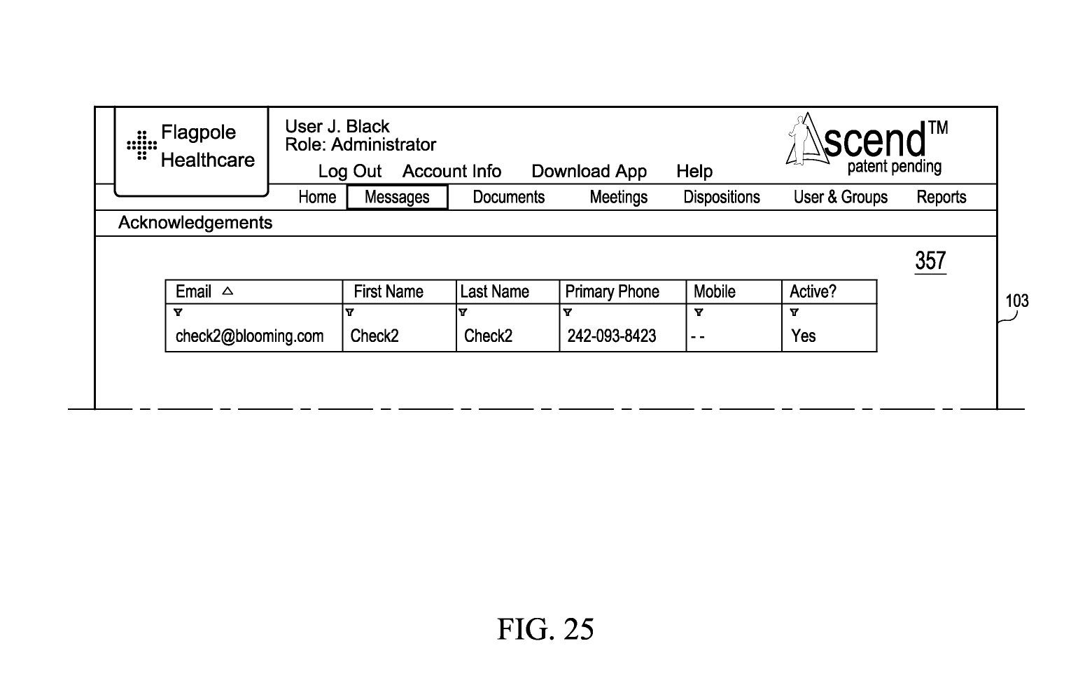

Similarly, for messages, FIG. 23 shows an illustrative screen layout 353 for a listing of messages and the status of distribution and other various features of messages created in the system 100, FIG. 24 shows an illustrative screen layout 355 for creating a message, including publication and expiration dates and group and individual recipients, and FIG. 25 shows an illustrative screen layout 357 listing the particular recipients that have acknowledged receipt of a selected message.

Selected meeting content or messages also be specified to require an “acknowledgment” response from the representatives 140 and other individuals within a certain time frame, or before a representative or other user is allowed to use a particular portion of the meeting process 200, offer a particular product using the meeting process 200, or access a particular portion of monitoring process 400. Additionally, the management application 131 can also alert an administrator if representatives 140 do not acknowledge particular document, message, or other distributions within a particular timeframe.

Other administrative aspects implemented by the management application 131 to facilitate the present system and functions include adding, removing, and updating information for the representatives 140, regions, products, compliant entity 145, and other such information necessary for the meeting process 200 and monitoring process 400. For example, particular representatives 140 may be trained and authorized on only particular products for a particular compliant entity 145. Such authorizations can be selected via the management application 131 and can inhibit or enable various in-the-field meeting activities 407 using the mobile application 113, and can also ensure that each representative 140 receives and acknowledges all meeting content and messages associated with those authorized products and carriers.

For example, the management application 131 can be set to prevent an individual representative 140 from certain activity by inhibiting use of all or portions of the meeting process 200 on their portable wireless device 111 if meeting content or messages associated with that particular activity (for example, including sales activity for a particular insurance plan) have not been uploaded or otherwise acknowledged, and any outdated data removed from the portable wireless device 111. For example, such removal of outdated meeting content and messages can occur automatically according to scripts or other feature provided by the mobile application 113 and its communication with the management application 131.

The system 100 can also provide scheduling of appointments and develop the scope of appointments information required by regulations for some products, for example for Medicare Advantage products. This may be facilitated by a component of the management application 131 or a separate scope of appointments application, such as a customer relationship management application 132 that can be integrated into the data connectivity of system 100 by the service layer application 109.

For example, a scope of appointments can be determined in part by utilizing the data available about the location, availability, and roles of the representatives 140. Thus, the system 100 can determine which representative may be available to satisfy the appointment requirements and the scope of appointments documentation can be developed accordingly, generally condensing the sales cycle into a shorter process and timeframe than is available with prior practices. Additionally, the scope of appointments information can be subsequently compared to the representative data available in the present system 100, including location, meeting, and disposition information to provide compliance and other analysis. If an existing CRM application 132 is utilized, it can be interfaced to automatically exchange data with the system 100, for example, via service layer interface 109.

The present system 100 can improve the process of setting and documenting an appointment for a meeting with a customer 143, for example, a customer 143 calling into a central call center agent 141, including for example, developing and documenting a scope of appointment. The system 100 enables and utilizes real-time representative information, including location and availability, transmitted to the central data system 101 by the portable wireless device 111. If a representative 140 is within a selected radius of the customer 143 or otherwise responsible for the customer's location, has a status of available, is qualified to make the sales call, and has an open schedule in the desired timeslot, the scheduler portion of the management application 131 or the separate interconnected application 132 can send a meeting request and obtain an immediate response from the representative through the portable wireless device 111. Alternative to checking the representative's schedule electronically, the call center representative 141 may teleconference in the representative with customer 143, thus allowing the representative 140 and customer 143 to meeting over the phone and set the time, purpose, and other scope detail for the meeting. The teleconferencing can be enabled by the mobile application 113 or another application of the portable wireless device 111, for example, using Voice over Internet Protocol (VoIP) known in the art.

Reports and Analysis

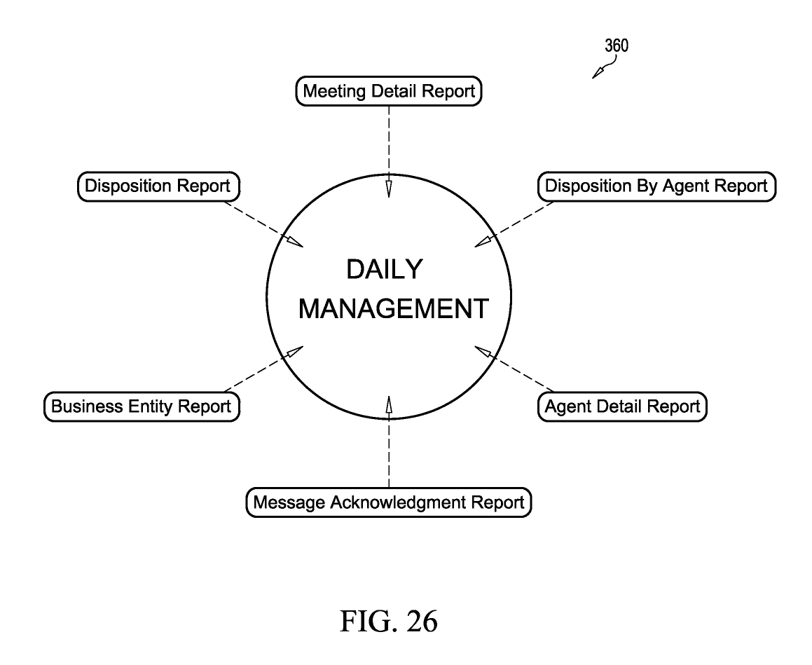

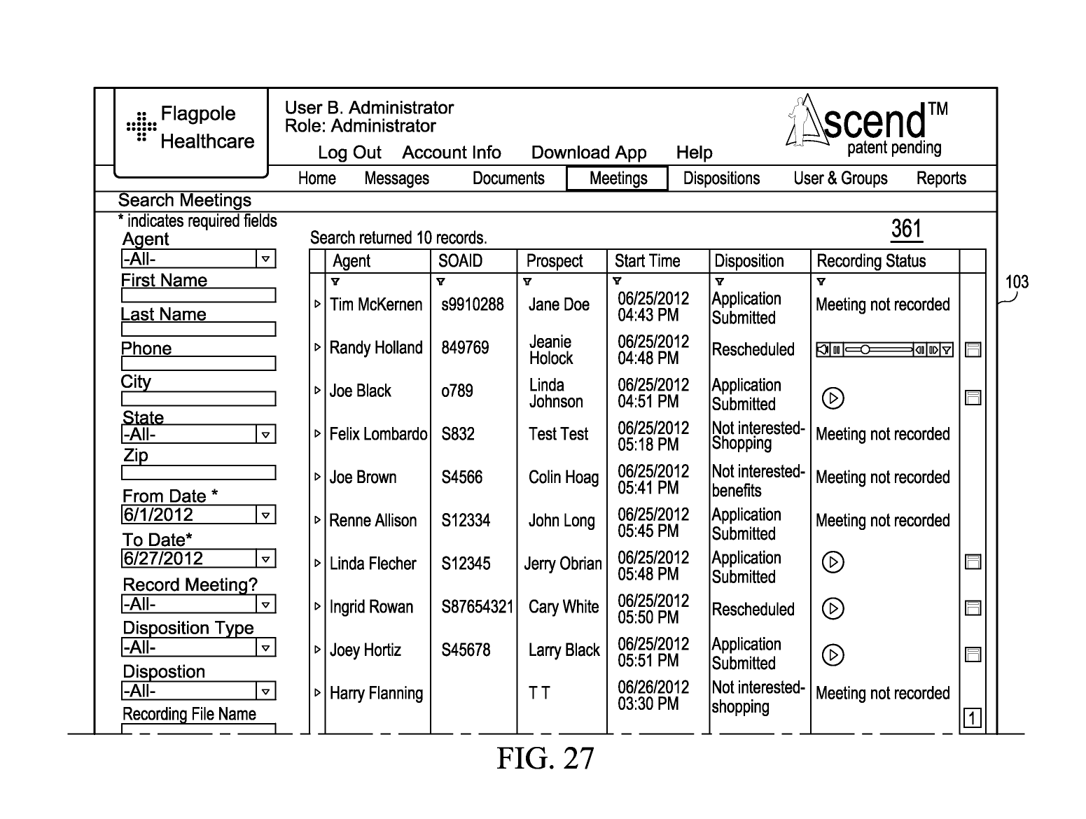

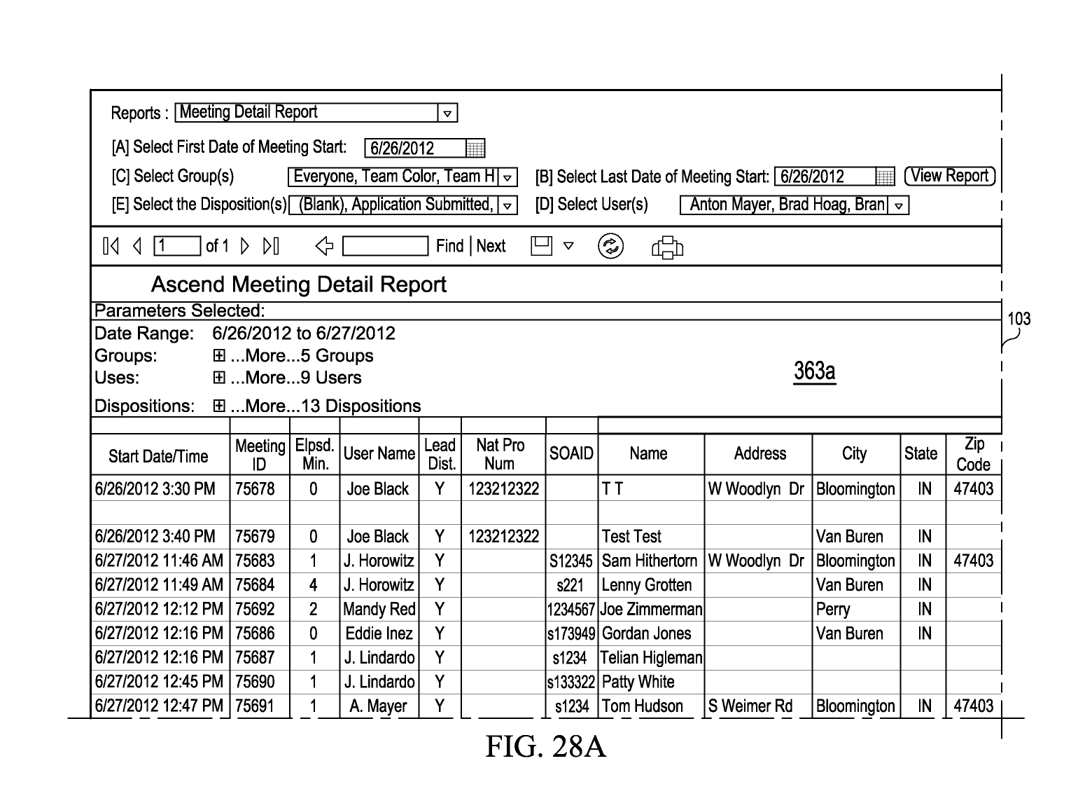

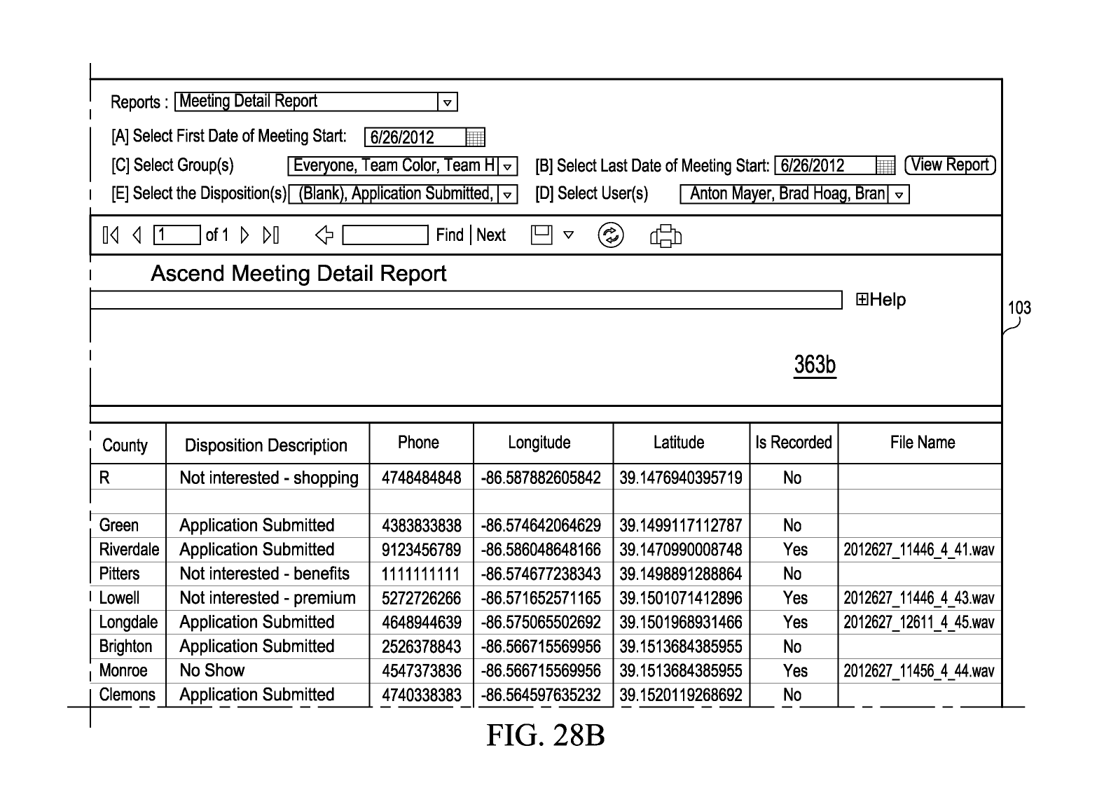

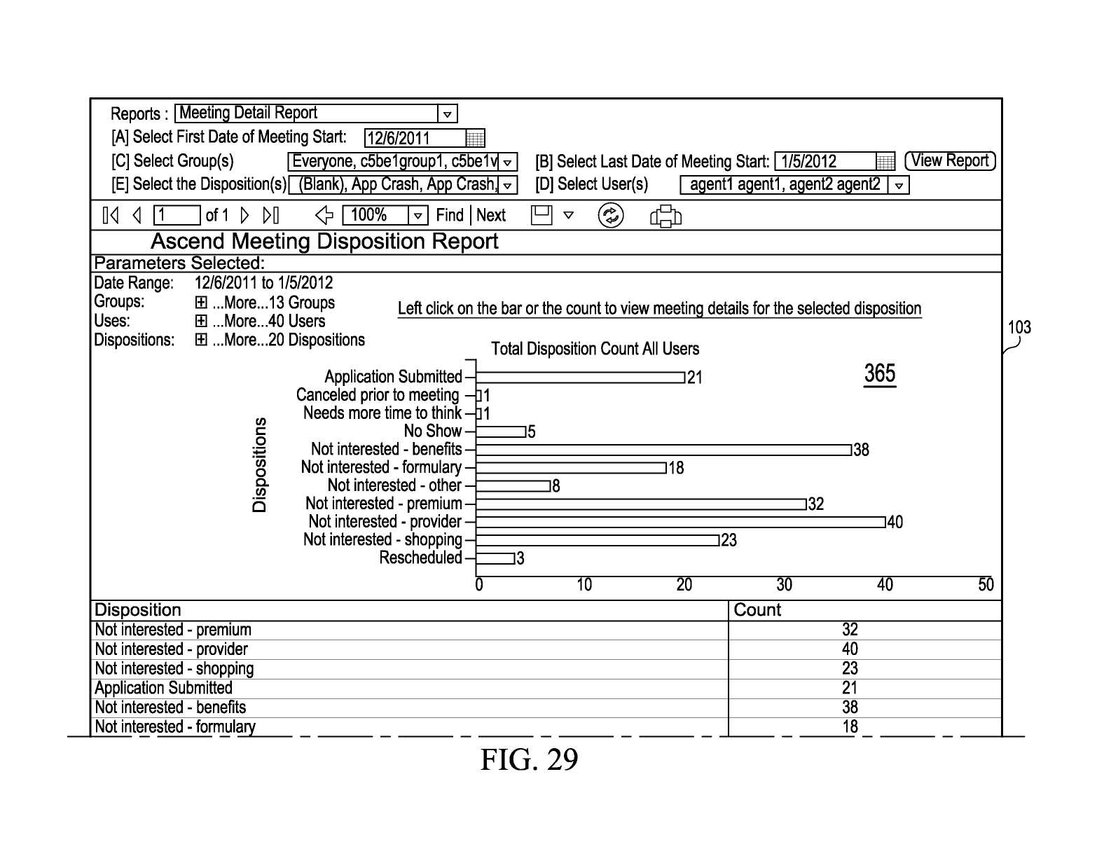

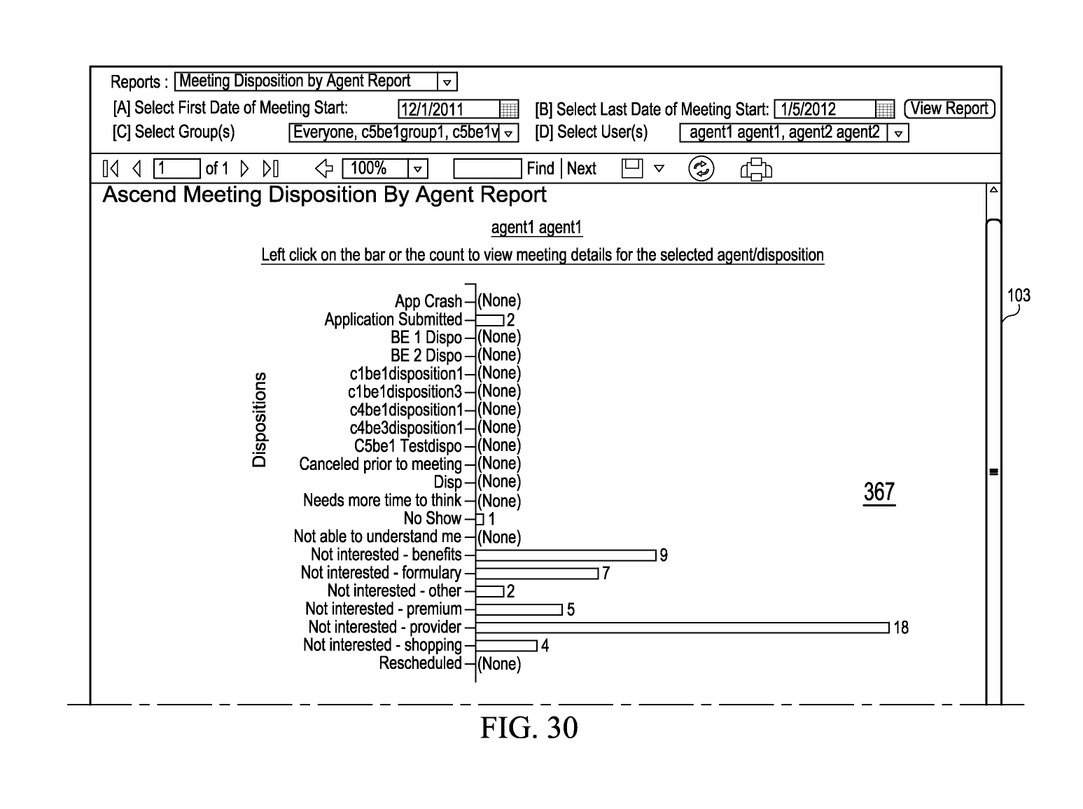

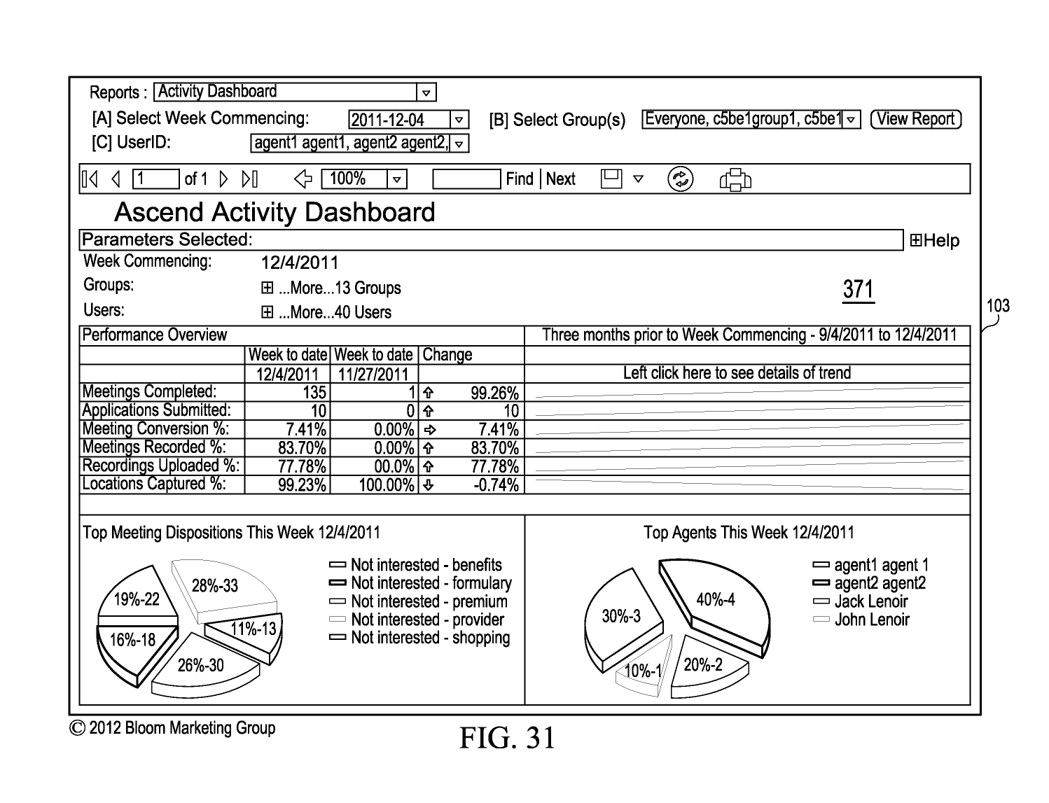

The management application 131 can also enable the compliance tools 150, including the analysis and reporting tools 153 of the analysis and reporting compliance step 413. For example, in the insurance industry analysis and reporting 413 can relate to representative performance, scope of appointments, sales calls, enrollments, and other aspects of compliance, including comparisons of data for a particular representative 140 to that of a group of representatives. For example, referring to FIG. 23, the reporting component of the management application 131 provides various standard and custom reports by accessing and analyzing the data stored in the database 105 and storage medium 107, as shown generally in monitoring features 360 shown in FIG. 26. For example, referring to FIGS. 27-31, example screen plans for the management application 131 provide meeting search and listing (screen layout 361 of FIG. 27 and screen layout 363a/b of FIGS. 28A and 28B), selection and review of recordings (right column of screen layout 361 of FIG. 27), and detailed meeting disposition reporting (screen layout 365 of FIG. 29), meeting disposition by agent reporting (screen layout 367 of FIG. 30), and an activity dashboard (screen layout 371 of FIG. 31) that can selectively track and display various performance indicators, for example, meetings completed, applications submitting, conversion rates, meetings recorded, recording uploaded, locations captured, meeting dispositions, top agents, and historical trending.

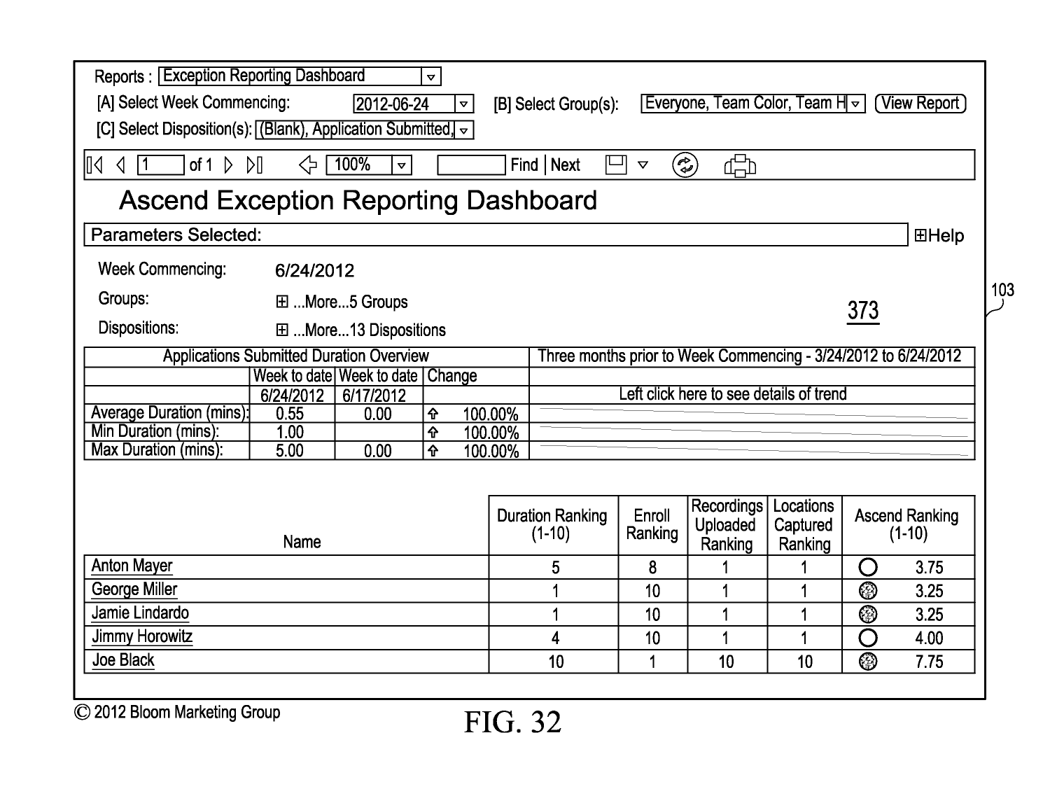

Referring to FIG. 32, additional examples of the compliance analysis and reports 413 and quality management 415 (FIG. 2) features include identifying exceptions that indicate possible compliance problems, such as those shown in an illustrative exceptions reporting dashboard 373. For example, identifying exceptions by tracking outcomes for particular events, including using a representative-to-representative pool comparison to determine performance and determine in what activities retraining or additional training is required, and in what activities compliance with policies, procedures, best practices, and legal requirements are likely being achieved. In a sense, such comparative analysis does not necessarily indicate non-compliance, but rather a likelihood or level or risk of non-compliance. For example, the system 100 can be used to determine for a particular representative 140 what percentage of customers 143 do not agree to be recorded and to compare this percentage with that of representatives overall.

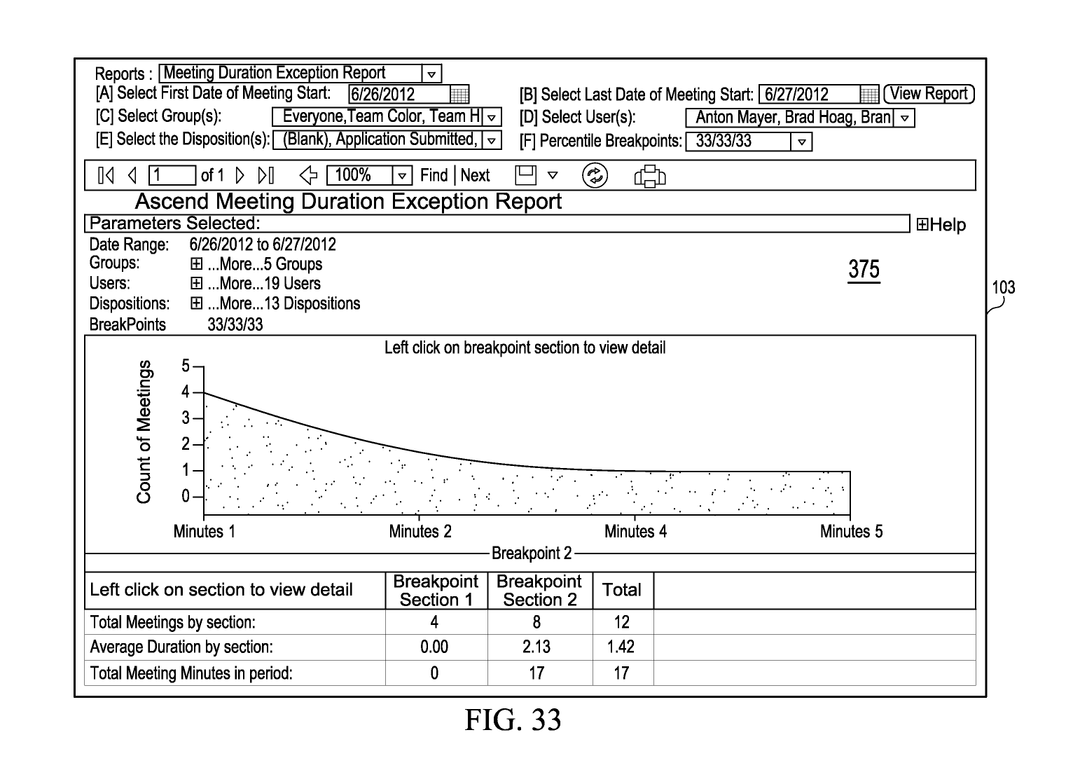

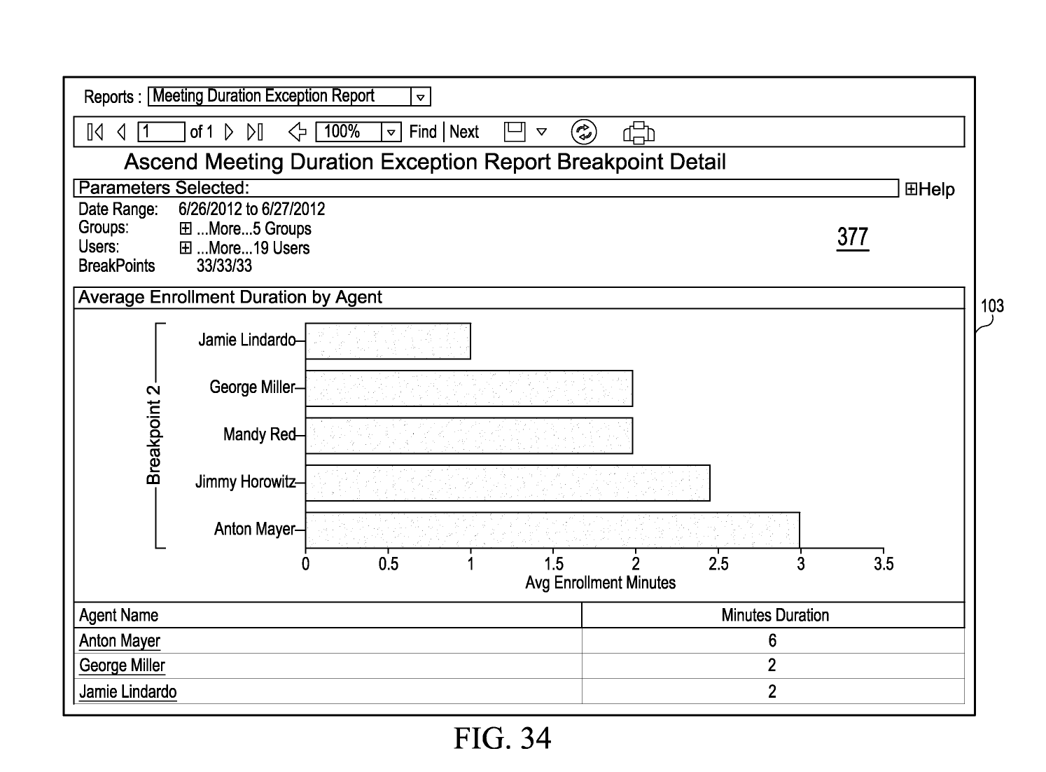

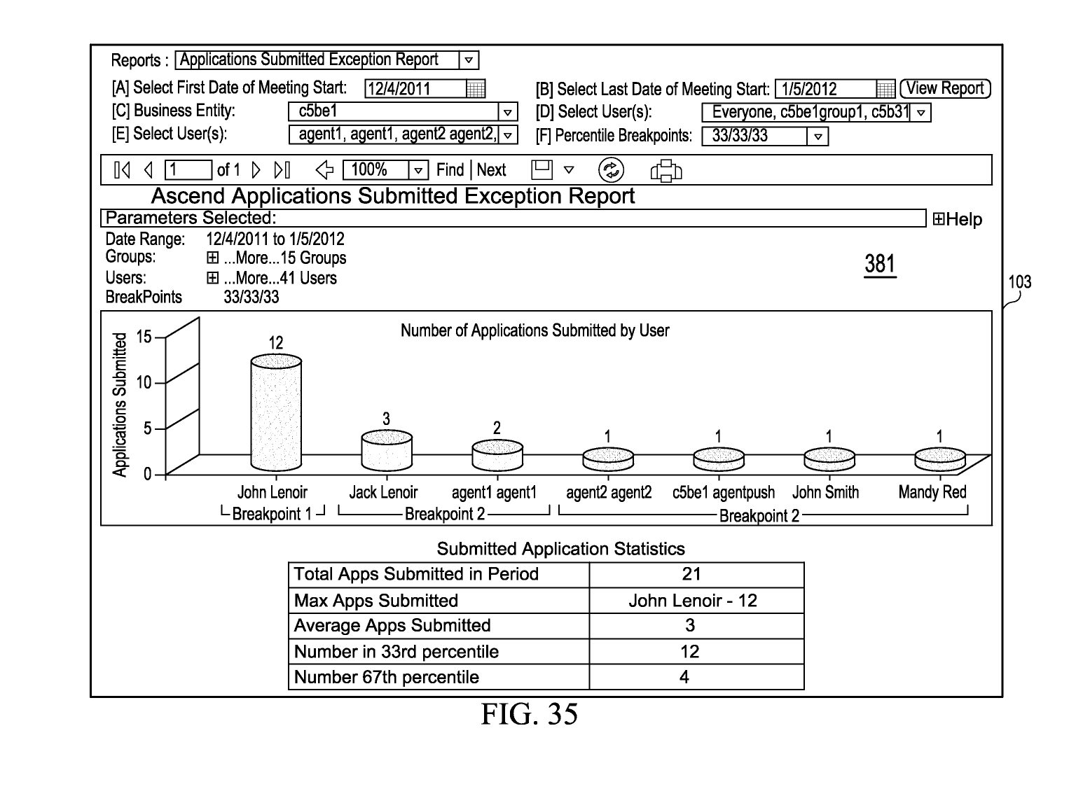

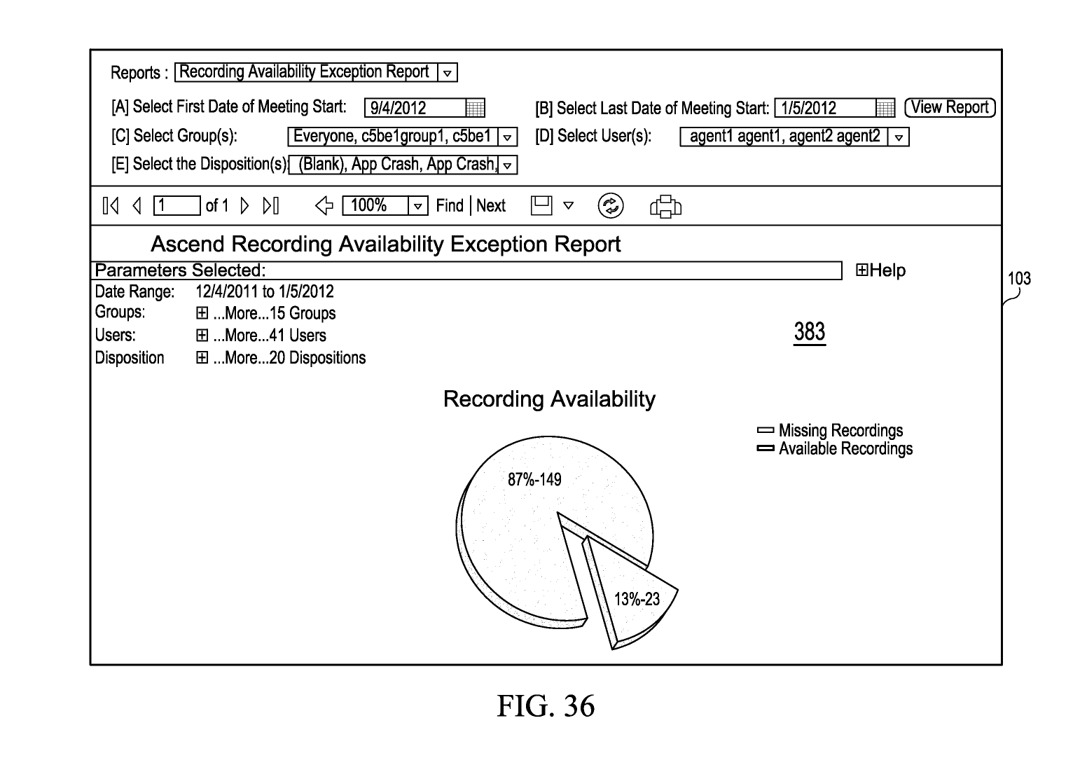

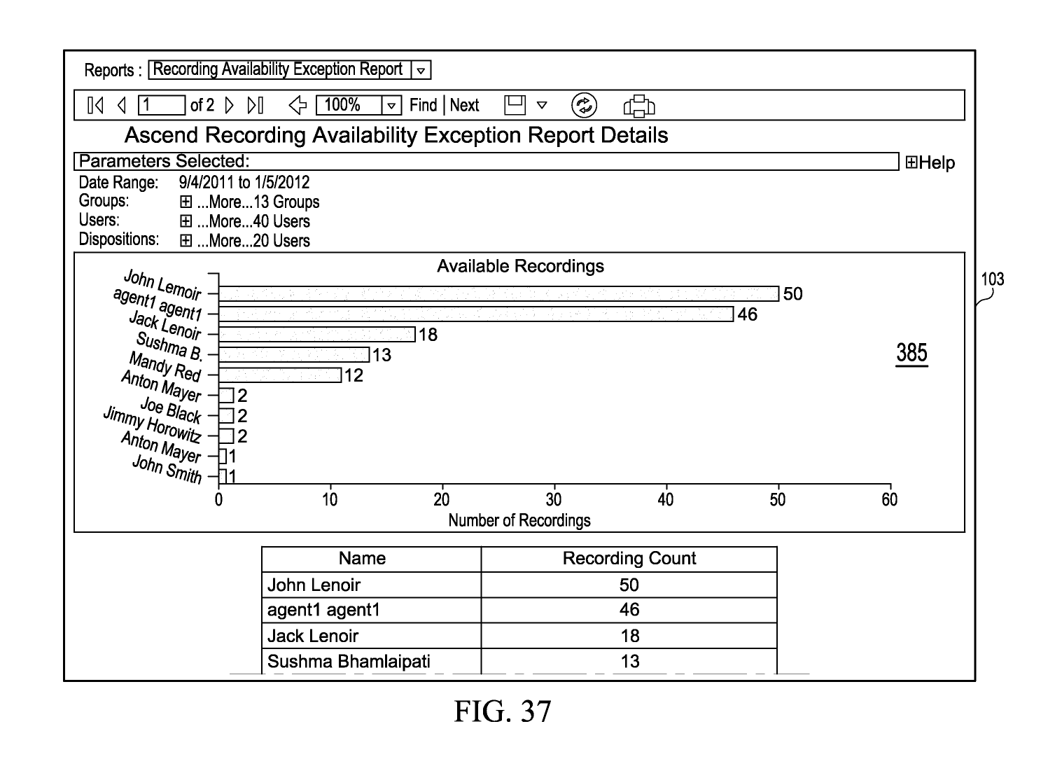

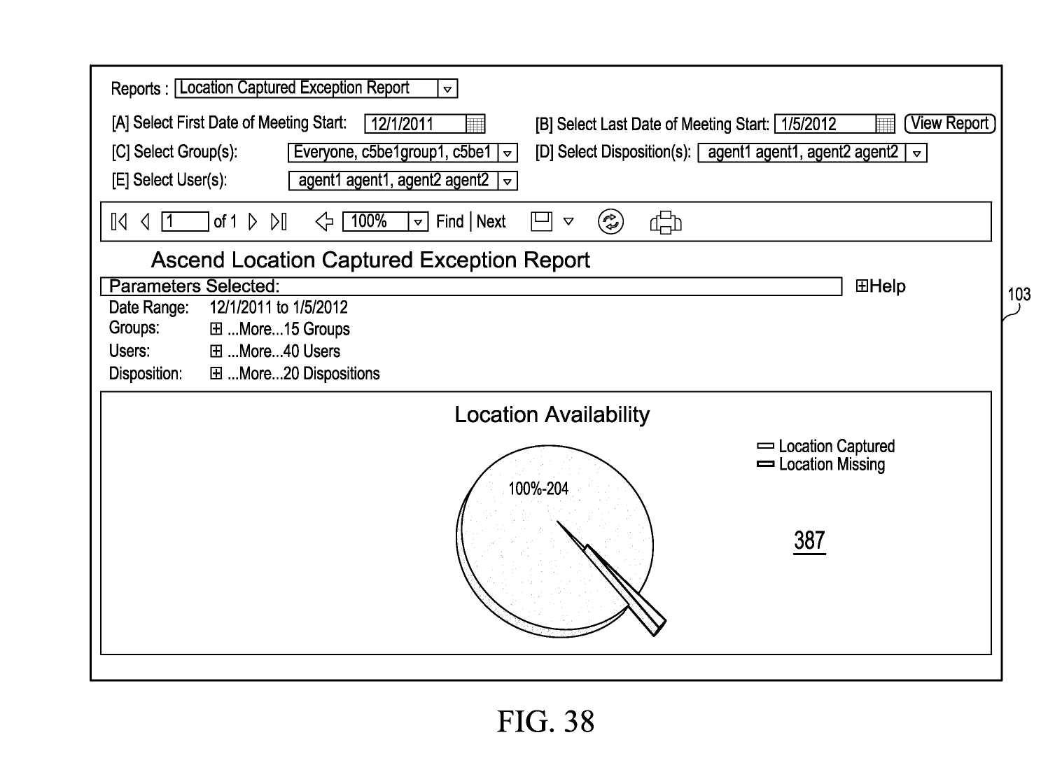

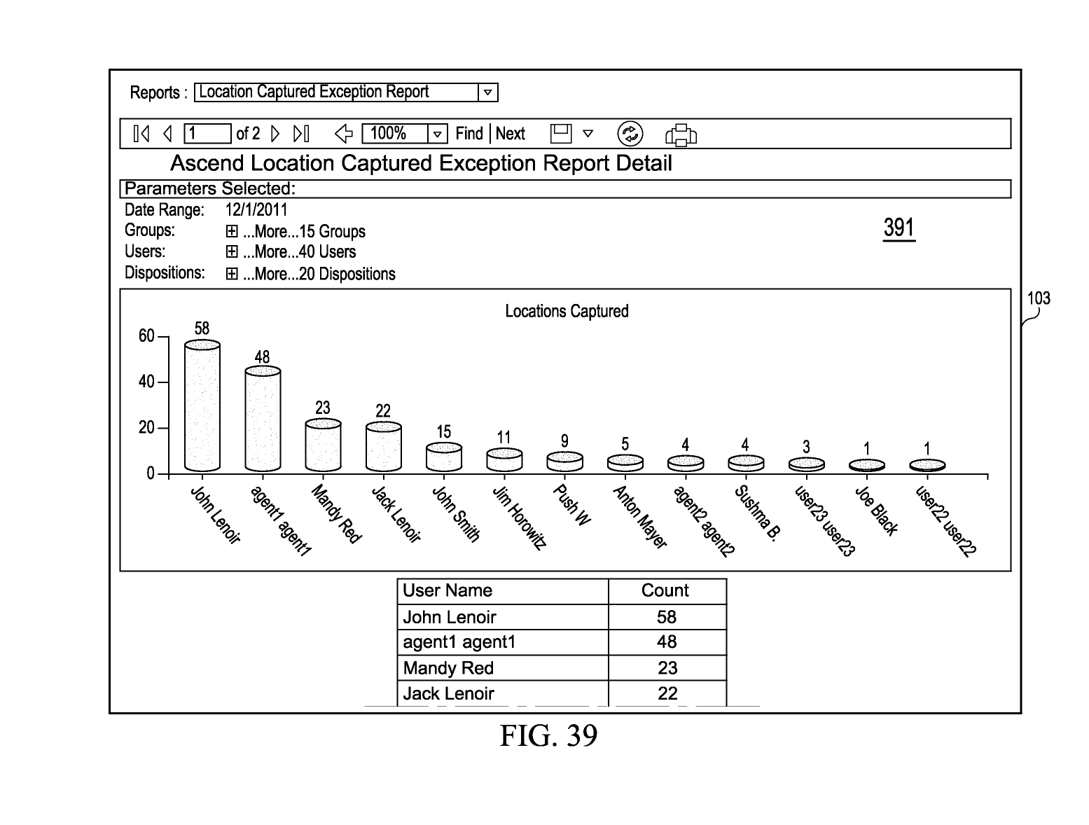

By identifying negative outliers for various activities or other outcomes, a possible elevated risk of noncompliance can be identified, and by identifying positive outliers, possible best practices by representatives can be identified and encouraged throughout the sales force. Additionally, other actions relating to analysis and reporting of compliance 413 and quality management 415 can be applied to such identified outliers, for example, as shown in FIG. 32. Outliers can be identified, for example, for activities and outcomes such as meeting duration as shown in screen layout 375 of FIG. 33 and screen layout 377 of FIG. 34, application submitted shown in screen layout 381 of FIG. 35, consent and/or availability to audio recordings shown in screen layout 383 of FIG. 36 and screen layout 385 of FIG. 37, rate of locations capture shown in screen layout 387 of FIG. 38 and screen layout 391 of FIG. 39, and/or other indicators/metrics.

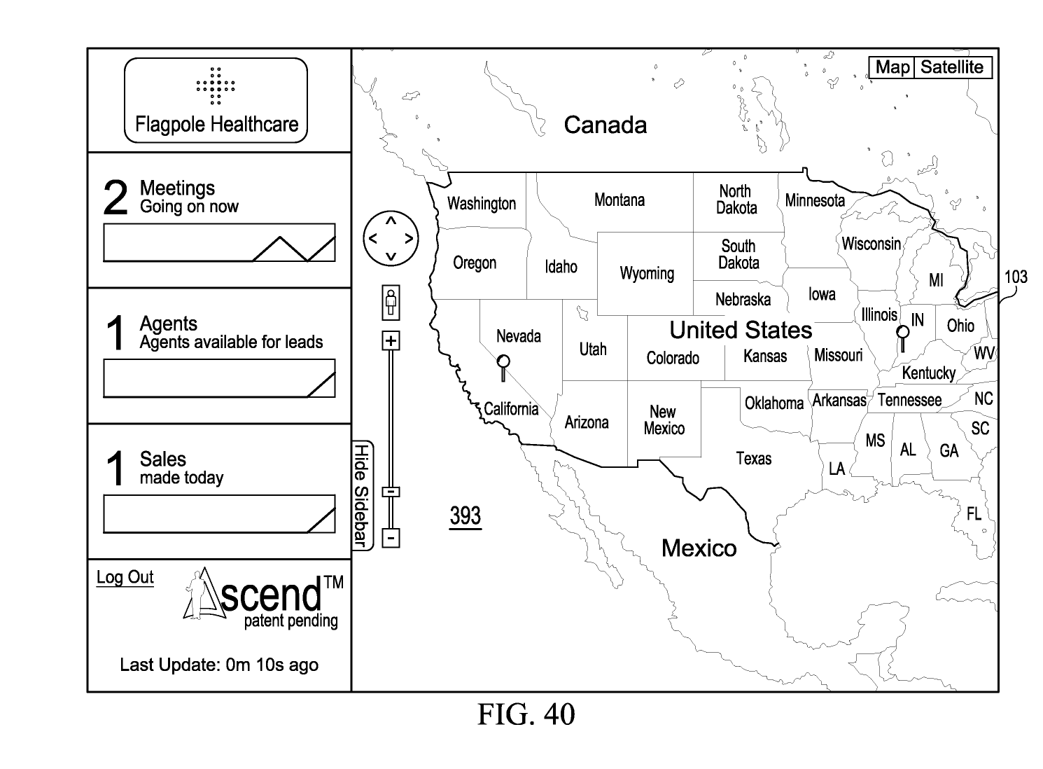

Referring to FIG. 40, real-time data such as meetings in progress, representatives available, and meetings or sales closed so far that day (or other period of time to the present) can be displayed along with a map 393 providing geographic distribution information, including, for example, the location of available representative and representative in a meeting.

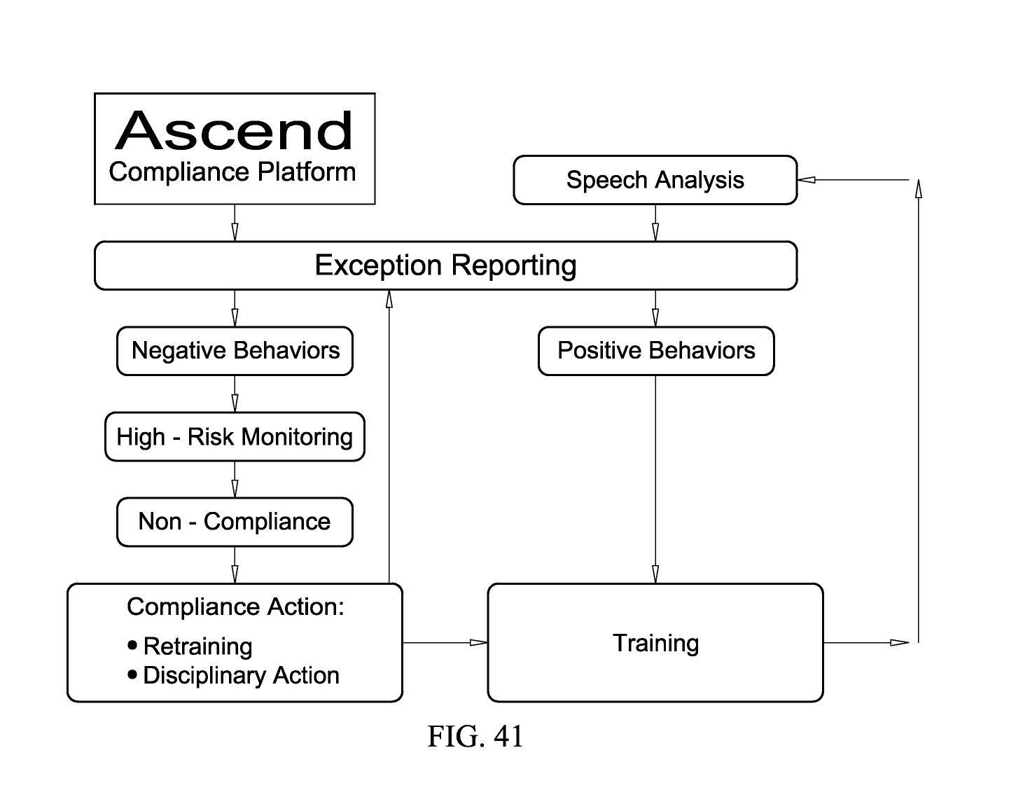

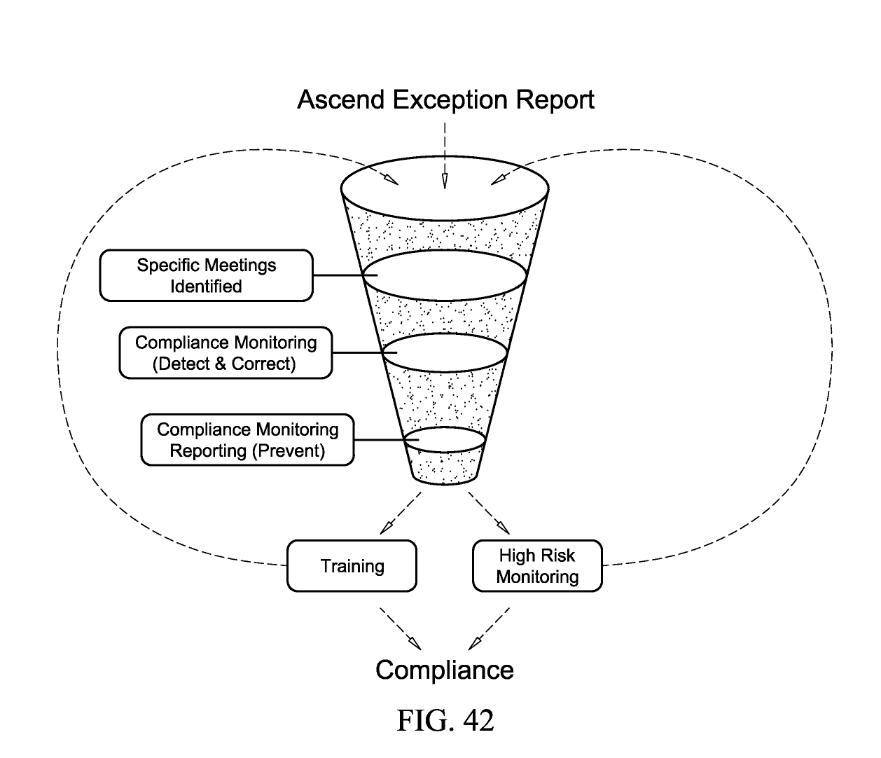

Referring to FIGS. 41 and 42, monitoring or other auditing and analysis of recordings and/or data sets collected during meetings can be completed to ensure compliance with regulatory requirements, policies, procedures, and best practices for a compliant entity 145. For example, a particular quality monitoring/auditing review program for the analysis and reporting step 413 and quality management step 415 can be tied to particular representatives. For example, new representatives, or representatives identified having lower compliance or meeting success (e.g. enrollment in an insurance plan) rates can have a higher percentage of their meeting recordings and/or data sets reviewed to help identify outlying areas of activity (whether problem or positive) that require additional training or retraining, disciplinary action, or other forms of remediation to improve outcomes, or recognition to reward and promote positive outcomes. Additionally, a particular or varied percentage of all representative's meeting recordings and/or data sets can be reviewed to develop any desired or required statistical and reporting requirements.

Quality monitoring or other auditing of recordings may include a speech analytics tool 151, for example, by integrating tools such as those available from Nexidia, Inc., of Atlanta, Ga. Such components can be set to identify the occurrence or non-occurrence of key phrases, words, inflections (reflecting, for example, emotion), or other aspects of human speech. Such occurrence or non-occurrences can also be determined relative to a particular portion of the audio recordings of the meetings based on indexing the recording to particular meeting activity or steps. Such indexing can be by elapsed time, or by collecting data during the recording to specifically index portions of the recording to specific meeting activity or steps being executed using the mobile application 113. Such a speech analytics tool 151 can automate review of audio recordings so that the entire recording need not be listened to by someone, or so that specific meeting audio recordings, or portions of audio recordings can be flagged for listening by someone and further consideration. The outcome can be used for remediation or recognition, as discussed above for the quality management step 415.

Such manual or automated review of meeting audio recordings and/or associated data sets may also determine particular archiving procedures. For example, identification of an issue may determine that the associated audio recording and data set be stored in a particular way or for a particular length of time. Generally, such archiving will be done in a secure, centralized data repository, for example, separate and possibly segregated from the central data system 101.

While the invention has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the claims and summary are desired to be protected.

1. A system for monitoring meetings of a representative with customers in the field, comprising:
a central data system having a management application;
a portable wireless device having a mobile application and geographic locating capability, the representative having the portable wireless device at meetings in the field with customers; and
a service layer application enabling communication between the mobile application and management application;
the mobile application enabling monitoring of meetings with customers, the monitoring including:
an availability status indicating at least whether or not the representative is presently available, the availability status transmitted immediately to the central data system;
a guided meeting process used by the representative, including:
presentation of meeting content;
collection of meeting information, including at least geographic location determined by the portable wireless device; and
collection of customer information; and
the meeting information and at least a portion of the customer information transmitted from the portable wireless device to the central data system and accessible by the management application.

2. The system of claim 1, wherein the management application enables compliance analysis and reporting based on the meeting information and customer information received by the central data system from the mobile application.

3. The system of claim 2, wherein the compliance analysis and reporting includes determining representatives having an averaged member of at least one of meeting information data and customer information data that is a statistical outlier.

4. The system of claim 3, wherein the compliance analysis and reporting includes comparison of representatives' rates of one of the meeting information data.

5. The system of claim 2, wherein the customer information includes insurance product enrollment information.

6. The system of claim 5, wherein the compliance analysis and reporting includes comparison of representatives' rates of enrollment.

7. The system of claim 2, wherein the meeting content includes insurance product offering and the guided meeting process further includes insurance product enrollment.

8. The system of claim 2, wherein the guided meeting process further includes validation that customer information and meeting information are compliant.

9. The system of claim 8, wherein the compliance analysis and reporting includes comparison of representatives' rates of compliance.

10. The system of claim 2, wherein the meeting information further includes a final disposition of the meeting with the customer, the final disposition selected from a plurality of possible dispositions.

11. The system of claim 10, wherein the compliance analysis and reporting includes comparison of representatives' rates for at least one of the plurality of possible meeting dispositions.

12. The system of claim 10, wherein the compliance analysis and reporting includes calculation and display of, for a selected period of time and a selected group of representatives, the number of meetings and meeting dispositions for at least one of the plurality of possible meeting dispositions.

13. The system of claim 2, wherein the meeting information further includes the length of the meeting with the customer.

14. The system of claim 12, wherein the compliance analysis and reporting includes comparison of representatives' average lengths of the meetings with customers.

15. The system of claim 2, wherein the portable wireless device further includes GPS capability and the geographic location is determined by the GPS capability.

16. The system of claim 2, wherein the availability status is determined by the representative selecting one of a plurality of different availability statuses selectable by a touchscreen softswitch displayed by mobile application.

17. The system of claim 2, wherein the mobile application enables transmission of the geographic location to the management application.

18. The system of claim 2, wherein:
the mobile application further enables storing on the portable wireless device meeting content for use in the meetings, the meeting content including documents; and
the monitoring further includes:
automatic updating of meeting content on the portable wireless device with documents published by the management application; and
the mobile application inhibiting the guided meeting process in the event updated meeting content is available from the management application and is not yet downloaded to the portable wire device.

19. The system of claim 18, wherein the compliance analysis and reporting includes calculation and display of, for a selected period of time and a selected group of representatives, a rate of downloading of meeting content to portable wireless devices.

20. The system of claim 18, wherein the management application further enables setting for each meeting content, a publish date on which the meeting content becomes available to the mobile application, and an expiration date on which the meeting content is no longer accessible using the mobile application.

21. The system of claim 2, wherein:
the mobile application further enables receiving messages from the management application; and
the monitoring further includes:
tracking acknowledgment of the messages, the acknowledgment provided by the representative using the portable wireless device; and
the mobile application inhibiting the guided meeting process if message designated as requiring acknowledgment is not yet acknowledged.

22. The system of claim 21, wherein the compliance analysis and reporting includes calculation and display of, for a selected period of time and a selected group of representatives, a rate of acknowledgment of messages.

23. The system of claim 21, wherein the management application further enables setting, for a message, a publish date on which the message becomes available using the mobile application, and an expiration date on which the message is no longer accessible using the mobile application.

24. The system of claim 2, wherein:
the monitoring further includes:
setting in the management application authorizations for the representative for particular meeting content; and
the guided meeting process inhibiting particular meeting content for which the representative lacks authorization.

25. The system of claim 2, wherein the monitoring further includes:
setting, in the management application the availability and features of meeting content based on a geographic location of the customer; and
the guided meeting process accessing meeting content based at least in part on the geographic location of the customer.

26. The system of claim 2, wherein:
the meeting information further includes whether the customer consented to recording of the meeting; and
the monitoring further includes audio recording of the meeting when consent is obtained from the customer.

27. The system of claim 26, wherein the compliance analysis and reporting includes comparison of representatives' rates of customers consenting to the recording of the meeting.

28. The system of claim 26, wherein the compliance analysis and reporting includes comparison of representatives' rates of transmission of audio recording of meetings to the central data system.

29. The system of claim 2, wherein:
the mobile application provides login credentials to the service layer application;
the service layer application transmits a time-limited token to the mobile application upon validation of login credentials;
the guided meeting process is enabled by the mobile application upon availability of a time-limited token that is unexpired and wireless conductivity between the portable wireless device and the central data system; and
a portion of the guided meeting process is disabled by the mobile application upon availability of a time-limited token that is unexpired and no availability of wireless conductivity between the portable wireless device and the central data system; and
the guided meeting process is disabled by the mobile application upon expiration of the time-limited token and no availability of wireless conductivity between the portable wireless device and the central data system to obtain an unexpired time-limited token.

30. The system of claim 2, wherein:
the mobile application enables a delay of transmission of meeting information and customer information until connectivity is available between the portable wireless device and the central data system; and
the mobile application inhibits the guided sales process if the delay of transmission exceeds at least one of a preset length of time and a preset number of meetings.

31. The system of claim 2, wherein the mobile application enables access to meeting content from a third-party server during the guided meeting process.

32. The system of claim 2, wherein the mobile application is integrated with a third-party customer relationship management system to exchange customer information and meeting information.

33. The system of claim 2, wherein the compliance analysis and reporting includes the number of meetings and meeting dispositions.

34. The system of claim 2, wherein the management application further enables display of a map indicating locations of representatives and there availability.

35. The system of claim 2, wherein the management application further enables display of an activity dashboard indicating statistics for a select period of time and selected group of representatives based on meetings, final disposition of meetings, audio recordings, and geographic locations captured.

36. The system of claim 2, wherein the management application further enables display of an exception dashboard indicating statistics for a select period of time and selected group of representatives based on meeting duration, final disposition of meetings, audio recordings, and geographic locations captured.

37. A system for monitoring meetings of a representative with customers in the field, comprising:
a central data system having an management application;
a portable wireless device having a mobile application and geographic locating capability, the representative having the portable wireless device at meetings in the field with customers; and
a service layer application enabling communication between the mobile application and management application;
the mobile application enabling monitoring of meetings with customers, the monitoring including:
a guided meeting process used by the representative, including:
presentation of insurance information;
collection of meeting information, including at least geographic location determined by the portable wireless device; and
collection of customer information, including at least insurance product enrollment information; and
the meeting information and at least a portion of the customer information transmitted from the portable wireless device to the central data system and accessible by the management application.

38. A method for monitoring meetings of a representative with customers in the field, comprising the steps of:
providing meeting content, including documents, using a central data system;
providing a portable wireless device, a login credential, and an authorization for particular meeting content to each of a plurality of representatives, the portable wireless device having geographic locating capability;
one of the plurality of representatives using a mobile application on the portable wireless device to conduct meetings, the mobile application enabling the further steps of:
validation of login credentials;
providing an availability status for the one of the plurality of representatives, the availability status indicating at least whether or not the representative is presently available and transmitted immediately to the central data system;
accessing the meeting content;
guiding the meeting;
audio recording of the meeting;
determining meeting information, the meeting information including geographic location determined by the portable wireless device;
determining customer information; and
transmission of audio recording, meeting information, and customer information to the central data system.

39. The method of claim 38, further comprising the steps of:
providing messages using a central data system; and
the one of the plurality of representatives acknowledging receipt of the messages.

40. The method of claim 38, wherein the meeting information includes a final disposition of the meeting.

41. The method of claim 38, wherein the meeting information includes a duration of the meeting.

42. The method of claim 38, further comprising the steps of:
obtaining consent to record audio of the meeting; and
transmitting whether consent was obtained to the central data system.

43. The method of claim 38, wherein the availability status is determined by the representative selecting one of a plurality of different availability statuses selectable by a touchscreen softswitch displayed by mobile application.

44. The method of claim 38, further comprising the step of the one of the plurality of representatives providing an availability status, and the availability status transmitted to the central data system.

45. The method of claim 38, further comprising the step of inhibiting particular meeting content for which the one of the plurality of representatives lacks authorization.

46. The method of claim 38, further comprising the step of inhibiting the mobile application from guiding the meeting process if more than a preset number of at least one of audio recordings or meeting information has not been transmitted to the central data system.

47. The method of claim 38, further comprising the step of inhibiting the mobile application from guiding the meeting process if the one of the plurality of representatives has not yet acknowledged a message designated as requiring acknowledgment.

48. The method of claim 38, further comprising the step compliance analysis and reporting for the plurality of representatives.

49. The method of claim 48, wherein the step of compliance analysis and reporting includes determining representatives of the plurality of representatives having an averaged member of at least one of meeting information data and customer information data that is a statistical outlier.

50. The method of claim 38, wherein the customer information includes insurance product enrollment information.

51. The method of claim 38, wherein the meeting content includes insurance product offering and the step of guiding the meeting includes insurance product enrollment.

52. The method of claim 38, further comprising the step of validating that customer information and meeting information are compliant.

53. The method of claim 38, further comprising the step of the central data server proving automatic updates of the meeting content stored on the portable wireless device.

54. The method of claim 38, further comprising the step of determining the meeting content for a meeting at least in part based on the geographic location of a customer attending that meeting.
